(19) United States
(12) Patent Application Publication
(10) Pub. No.: US 2019/0034899 A1
(43) Pub. Date: Jan. 31, 2019

(54) DETACHABLE CARD READER MOUNTING SYSTEM

(71) Applicant: Walmart Apollo, LLC, Bentonville, AR (US)

(72) Inventors: Joe Speagle, Bentonville, AR (US); Paul Mabry, Fayetteville, AR (US)

(21) Appl. No.: 16/015,190

(22) Filed: Jun. 22, 2018

Related U.S. Application Data
(60) Provisional application No. 62/539,430, filed on Jul. 31, 2017.

(51) Int. Cl. G06Q 20/20; G06K 7/10

(52) U.S. Cl. CPC G06Q 20/204; G06K 7/10366

(57) ABSTRACT

Examples provide a detachable card reader mounting system. A latching mechanism removably attaches a mounted card reader to a point-of-sale (POS) fixture for utilization in a fixed position. The latching mechanism detaches the mounted card reader from the POS fixture for utilization in a non-fixed position. This enables a user to hold the mounted card reader and adjust a location, proximity, and/or height of the mounted card reader to suit individual preferences of each user. A security cable anchors the mounted card reader to the POS fixture to prevent loss of the detached card reader. A padded ring holder provides a handle for a user to grip when it is detached from the POS fixture. A retractor device autonomously retracts the security cable to return the mounted card reader to a point of attachment on the POS fixture when detachment of the mounted card reader is no longer indicated.

### BACKGROUND

A card reader is a payment device for reading data from a magnetic strip, a microchip, or other storage medium embedded within a card-shaped object, such as, but not limited to, a credit card, a debit card, a gift card, or other payment storage medium. A card reader may include, without limitation, a chip card reader for reading data from a microchip or a magnetic card reader for reading data from a magnetic stripe card.

Card readers are frequently utilized to complete payment transactions at stores and other retail locations. These card readers are typically embedded or integrated within stationary payment systems, such as a point-of-sale (POS) device. However, it is frequently difficult to determine where the card reader should be mounted for most convenient access by all users. For example, a card reader mounted at a height which is preferred by an adult standing upright may be considered too high by another user sitting in a motorized cart. Likewise, a card reader mounted at a height preferred by a four-foot-tall user may be considered too low by another six-foot-tall user.

### SUMMARY

Some examples of the disclosure provide a detachable card reader mounting system. An outer mounting ring assembly includes a ring holder attached to a base plate. The base plate includes a card reader mounted to at least a portion of the base plate. A first end of a retractable set of cables is connected to the mounted card reader and a second end of the retractable set of cables is connected to an interior cavity of a cable housing embedded within a portion of a counter of a point-of-sale (POS) fixture. The retractable set of cables are threaded through an aperture within the base plate. A retractor device automatically retracts the set of cables within the cable housing in response to returning the outer mounting ring assembly to a point of attachment associated with the POS fixture. A solenoid release device removably attaches the outer mounting ring assembly to the portion of the counter of the POS fixture at the point of attachment in a locked configuration of the outer mounting ring assembly. The solenoid release device unlocks or detaches the outer mounting ring assembly from the portion of the counter of the POS fixture in response to receiving a release signal. The retractor device releases at least one cable in the set of cables to enable at least a portion of the at least one cable to extend outside the cable housing during detachment of the outer mounting ring assembly from the POS fixture.

Other examples provide an outer mounting ring assembly including a ring holder, a base plate, and a card reader device mounted to the outer mounting ring assembly. The ring holder includes a set of contact points. A latching mechanism removably attaches the outer mounting ring assembly to a portion of a member of a POS fixture at a point of attachment by a latching mechanism. The latching mechanism releases the outer mounting ring assembly enabling the mounted card reader device to detach from the POS fixture in response to detecting user contact with the set of contact points for a contact threshold time. A retractable set of cables attached to the mounted card reader device includes a security cable and a communications cable. A first end of the security cable is coupled to the mounted card reader device and a second end of the security cable is coupled to a cable housing. At least a portion of the cable housing is coupled to part of the POS fixture. The security cable extends out of the cable housing as a user holding the mounted card reader device moves away from the point of attachment associated with the POS fixture. A retractor device self-retracts the security cable back into the cable housing in response to the user relinquishing the mounted card reader device. The retractor device returns the mounted card reader device to the point of attachment associated with the POS fixture.

Still other examples provide a detachable card reader mounting system. An outer mounting ring assembly includes a ring holder, a base plate configured to mount a card reader device to the outer mounting ring assembly, and a latching mechanism configured to removably attach the outer mounting ring assembly to a portion of a POS fixture at a point of attachment. The latching mechanism includes a connector component associated with the outer mounting ring assembly and a receiver component associated with the portion of the POS fixture. The latching mechanism is configured to release the outer mounting ring assembly enabling the outer mounting ring assembly to detach from the POS fixture in response to rotation of the latching mechanism in a first direction until the latching mechanism releases the outer mounting ring assembly. A cable housing is configured to enclose a retractable set of security cables. The retractable set of security cables includes a first end of at least one security cable coupled to the card reader and a second end of the at least one security cable coupled to a portion of the cable housing. The security cable extends as the detached outer mounting ring assembly moves away from the point of attachment. A retractor device autonomously retracts the at least one security cable into the cable housing when the detached outer mounting ring assembly is relinquished by a user. The retractor device returns the detached outer mounting ring assembly to the point of attachment associated with the POS fixture. The latching mechanism locks the outer mounting ring assembly to a portion of the POS fixture in response to rotation of the latching mechanism in a second direction until the latching mechanism engages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a detachable card reader mounting system.

FIG. 2 is an exemplary block diagram illustrating a detachable card reader mounting system including a set of sensors.

FIG. 3 is an exemplary block diagram illustrating a computing device for analyzing sensor data.

FIG. 4 is an exemplary front elevation view of a set of detachable card reader mounting devices.

FIG. 5 is an exemplary back perspective view of the detachable set of detachable card reader mounting devices.

FIG. 6 is an exemplary side elevation view of the set of detachable card reader mounting devices.

FIG. 7 is an exemplary block diagram illustrating a system including a detachable mounting device for a card reader.

FIG. 8 is an exemplary block diagram illustrating an outer mounting ring assembly.

FIG. 9 is an exemplary perspective view of a detachable mounting device for a card reader.

FIG. 10 is an exemplary perspective view of an outer mounting ring assembly.

FIG. 11 is an exemplary front view of a detachable mounting device.

FIG. 12 is an exemplary side view of a detachable mounting device.

FIG. 13 is an exemplary perspective view of a side of a detachable mounting device.

FIG. 14 is an exemplary plan view of a cable housing.

FIG. 15 is an exemplary front view of a cable housing.

FIG. 16 is an exemplary perspective view of a cable housing.

FIG. 17 is an exemplary side view of a cable housing.

FIG. 18 is an exemplary cross section of a ring holder.

FIG. 19 is an exemplary plan view of a ring holder.

FIG. 20 is an exemplary perspective view of a ring holder.

FIG. 21 is an exemplary plan view of a base plate.

FIG. 22 is an exemplary perspective view of a base plate.

FIG. 23 is an exemplary plan view of a front of a swivel assembly.

FIG. 24 is an exemplary plan view of a back of a swivel assembly.

FIG. 25 is an exemplary perspective view of a swivel assembly.

FIG. 26 is an exemplary plan view of a side of a swivel assembly.

FIG. 27 is an exemplary plan view of a connector portion of a latching mechanism.

FIG. 28 is an exemplary side view of a connector portion of a latching mechanism.

FIG. 29 is an exemplary perspective view of a connector portion of a latching mechanism.

FIG. 30 is an exemplary side view of a connector portion of a latching mechanism.

FIG. 31 is an exemplary plan view of a receiver portion of a latching mechanism.

FIG. 32 is an exemplary cross-section of a receiver portion of a latching mechanism.

FIG. 33 is an exemplary plan view of a latching mechanism.

FIG. 34 is an exemplary perspective view of a receiver portion of a latching mechanism.

FIG. 35 is an exemplary front elevation view of an attachment member for a cable housing.

FIG. 36 is an exemplary back elevation view of a cable housing.

FIG. 37 is an exemplary perspective view of a cable housing.

FIG. 38 is an exemplary side view of a cable housing.

FIG. 39 is an exemplary plan view of a weight rod.

FIG. 40 is an exemplary perspective view of a weight rod.

FIG. 41 is an exemplary cross-section view of a weight rod.

FIG. 42 is an exemplary perspective view of a reel associated with a retractor device.

FIG. 43 is an exemplary perspective view of a top of a solenoid release device.

FIG. 44 is another exemplary perspective view of a top of a solenoid release device.

FIG. 45 is yet another exemplary perspective view of a top of a solenoid release device.

FIG. 46 is an exemplary perspective view of a bottom of a solenoid release device.

FIG. 47 is another exemplary perspective view of a bottom of a solenoid release device.

FIG. 48 is an exemplary perspective view of a threaded receiver device.

FIG. 49 is an exemplary perspective view of a solenoid release device.

FIG. 50 is an exemplary flow chart illustrating operation of the computing device to generate a release signal to self-release the outer mounting ring assembly.

Corresponding reference characters indicate corresponding parts throughout the drawings.

### DETAILED DESCRIPTION

Referring to the figures, examples of the disclosure enable a detachable card reader device mounting system. In some examples, an outer mounting ring assembly is provided. A card reader device is mounted to the outer mounting ring assembly. The outer mounting ring assembly provides a padded ring holder for a user to grip when holding or moving the mounted card reader. This improves user comfort and convenience when utilizing the mounted card reader and prevents discomfort or potential injury due to metal parts, rough surfaces, or sharp edges on the outer mounting ring assembly. The outer mounting ring assembly further provides multiple contact points or areas for a user to grip at multiple different angles relative to the card reader device, such that a grip contact with the ring assembly may be obtained from any position relative to the circumference of the ring assembly to accommodate multiple different types of grip contacts.

A set of contact points on the mounted card reader device in some examples enable a latching mechanism to automatically detach the mounted card reader from a point-of-sale (POS) fixture in response to a user touching, holding, pressing, or otherwise contacting one or more of the contact points. This enables a user to easily detach the mounted card reader device from the POS fixture for use without requiring complex instructions or explanations regarding detachment of the mounted card reader.

In other examples, a latching mechanism automatically detaches the mounted card reader device from the POS fixture if the system determines the user is disable, unable to easily reach/utilize the mounted card reader while it is attached to the POS fixture, or the user has otherwise indicated a preference for detaching the mounted card reader device when completing transactions. This enables a user to complete a transaction using a mounted card reader device in a position and at a location which is most convenient to the individual user.

The system in some examples analyzes sensor data, including video camera image data, radio frequency identification (RFID) tag data, user device identification data, mobile aid device recognition data, and user height recognition data to automatically determine whether to detach the mounted card reader device for use by a user. For example, if the system determines that the mounted card reader device is located in a position which is inconvenient (too low) for a taller user, the system automatically detaches the card reader device for use by this user. This enables the user to move/adjust the height of the mounted card reader device and place it in a location which is most comfortable, convenient, and preferred by the user.

In another example, the system analyzes sensor data to determine if a selected user approaching a POS fixture to complete a transaction is in a sitting position, riding a motorized cart, or otherwise utilizing a mobility aid device, such as a wheelchair or motorized chair, to determine whether to automatically self-release the mounted card reader device for a particular user. If the orientation of the user indicates a sitting position, the user is utilizing a mobility aid device, and/or the user is riding in a motorized cart, the system automatically releases the mounted card reader from the POS fixture to enable the user to hold the mounted card reader, place the mounted card reader in the user's lap, place the mounted card reader on a lower shelf or other surface, or otherwise move the mounted card reader to a position/location preferred by the user. This provides improved user satisfaction, increases card reader transaction efficiency, and creates various options for placement of mounted card readers such that mounted card reader positioning during performance of transactions may be customized for each individual user. This further reduces time spent by a user attempting to utilize a card reader device located in an inconvenient location while simultaneously improving user efficiency in completing transactions.

A retractable set of cables including at least one security cable is provided by other examples. The security cable anchors the mounted card reader device to a point of attachment on the POS fixture. This prevents loss, theft, or misplacement of the mounted card reader device when it is detached from the POS fixture. Moreover, the security cable prevents the mounted card reader device from being moved away from the POS fixture a distance greater than a length of the security cable. In this manner, the length of the security cable dictates a maximum distance the mounted card reader device may be moved away from the POS fixture. This feature enables improved monitoring and security of mounted card reader devices while ensuring a location of the mounted card reader device may be readily determined.

In other examples, a retractor device self-retracts the security cable into the cable housing in response to the user relinquishing the mounted card reader device coupled to the outer mounting ring assembly. A user relinquishes the mounted card reader device if the user lets go of the mounted card reader device, drops the mounted card reader device, or stops interacting with the mounted card reader device (absence of user input to the mounted card reader device) for a threshold inactivity time. When the user relinquishes the mounted card reader device that is detached from the POS fixture, the retractor device automatically retracts the set of cables attached to the mounted card reader device to return the mounted card reader device to the point of attachment associated with the POS fixture. This enables the mounted card reader device to be returned to its designated location on the POS fixture with minimal user intervention or with no user intervention.

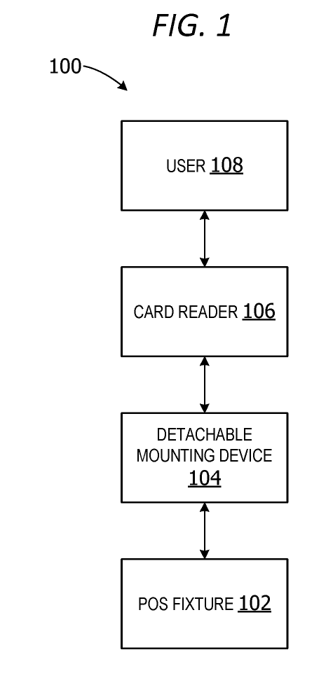

Referring to FIG. 1, an exemplary block diagram illustrates a detachable card reader mounting system 100. The system 100 includes a fixed point-of-sale (POS) fixture 102. The POS fixture 102 is a fixed location at which transactions, such as retail purchases, may be performed and/or completed. The POS fixture may be referred to as a stationary payment apparatus. The POS fixture 102 may be implemented as a counter, desk, kiosk, or other structure associated with a POS device, such as, but not limited to, a card reader 106.

The card reader 106 in this example is a payment device for processing payments or obtaining payment information from a credit card, debit card, gift card, or other payment information storage medium. Payment information may include a user's name, address, account number, credit limit, account balance, card expiration date, card validation code, name of a financial institution, gift card balance, etc. The card reader 106 may be a magnetic card reader or a chip card reader. In some non-limiting examples, the card reader 106 may be a device capable of accepting cryptocurrency, such as BITCOIN™. In some examples, the card reader decodes payment information from a magnetic strip or microchip embedded in a card and utilizes this information to transmit payment data to a payment processor to verify sufficient funds are available in a user account to complete a current transaction.

The card reader 106 in this example is coupled to a detachable mounting device 104. The detachable mounting device 104 is removably attached to the POS fixture 102 in another example.

In some examples, the detachable mounting device 104 is secured to a first position associated with a surface of a counter or other member of the POS fixture 102 when the detachable mounting device 104 is in a locked configuration. In these examples, the card reader 106 attached to the detachable mounting device 104 is held securely at the first position associated with the surface of the POS fixture 102. The card reader 106 may pivot forward or backward on an axis associated with the detachable mounting device 104, but the card reader 106 may not be detached from the surface of the POS fixture 102 to another location in the locked configuration.

When the detachable mounting device 104 is in an unlocked (released) configuration, at least a portion of the detachable mounting device 104 and the card reader 106 coupled to the portion of the detachable mounting device 104 may be moved from the first position on the surface of the POS fixture 102 to a second position located remotely from the surface of the POS fixture 102. In other words, a portion of the detachable mounting device 104 may be unlocked or released from the POS fixture 102 to enable a user 108 to hold the card reader 106 in the user's hand or in the user's lap, or otherwise remote from the POS fixture 102, while completing a transaction. When the transaction is complete, the user 108 may return the card reader 106 attached to the detachable mounting device 104 to the first position on the surface of the POS fixture 102. The detachable mounting device 104 may be returned to the locked configuration to ensure the card reader 106 remains in the first position until detachment of the card reader 106 from the POS fixture 102 by another user is desired.

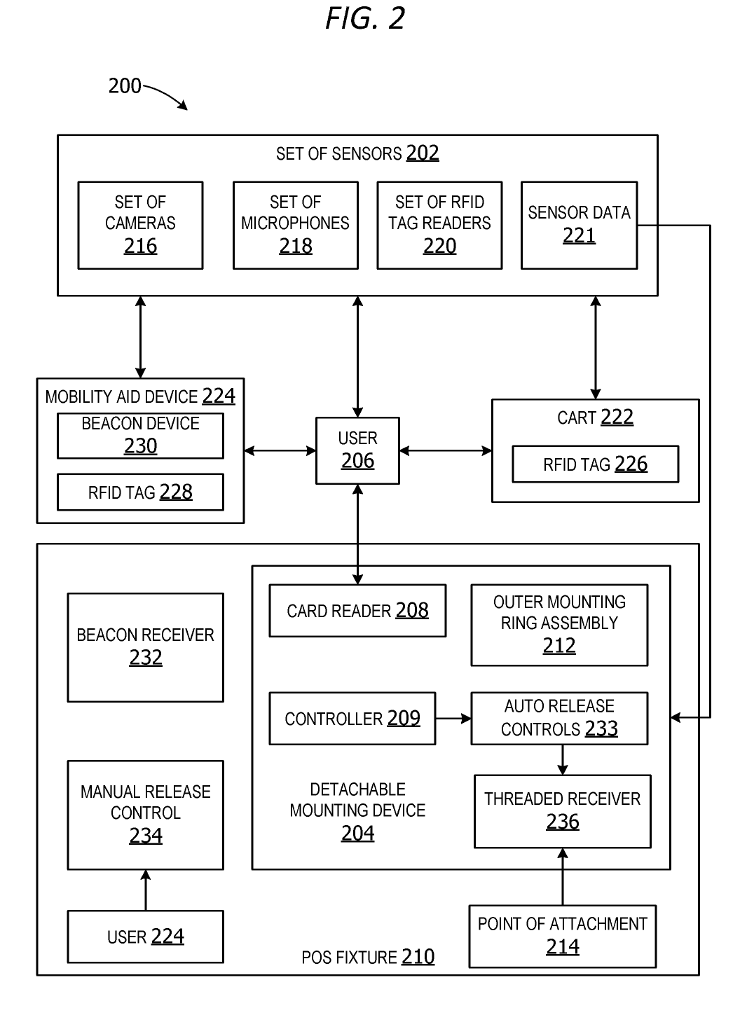

FIG. 2 is an exemplary block diagram illustrating a detachable card reader mounting system 200 including a set of sensors 202. The set of sensors 202 includes one or more sensors for determining whether to release a detachable mounting device 204 from a locked configuration to an unlocked configuration enabling a user 206 to move a card reader 208 mounted on an outer mounting ring assembly 212 of the detachable mounting device 204 away from a point of attachment 214 on a POS fixture 210. The detachable mounting device 204 is a device for removably detaching and attaching a card reader 208 to a point of attachment 214 on a POS fixture 210, such as, but not limited to, the detachable mounting device 104 in FIG. 1.

The set of sensors 202 generate sensor data 221 which is analyzed by controller 209 of detachable mounting device 204 to determine whether the user 206 may intend to detach the card reader 208 from the POS fixture 210. The user 208 may intend to detach the card reader 208 if the user 206 is disabled or would otherwise encounter difficulty using the card reader 208 in its current location attached to the POS fixture 210. If controller 209 determines user 206 may intend to detach card reader 208, controller 209 may send instructions to, or otherwise control, auto release controls 233 associated with threaded receiver 236 to unlock the outer mounting ring assembly from the POS fixture at the point of attachment 214 and automatically place outer mounting ring assembly 212 in an unlocked position, facilitating ease of detachment of card reader 208 for user 206.

In this non-limiting example, the set of sensors 202 includes a set of one or more cameras 216, a set of one or more microphones 218, and/or a set of one or more radio frequency identification (RFID) tag readers 220. The set of cameras 216 may include any type of image capture devices, such as, but not limited to, a video camera, a camera for capturing still images, an infrared camera, or any other type of image capture device.

In one example, the set of cameras 216 captures image data associated with the user 206. A computing device (not shown) may analyze the image data to determine a height of the user 206. If the user's height is greater than or less than a threshold height range, the user 206 may find the card reader 208 located at the current point of attachment 214 to be too low or too high. If the height of the user is outside the threshold height range (maximum height threshold and/or minimum height threshold), the detachable mounting device 204 releases the outer mounting ring assembly 212 enabling the user 206 to detach the card reader 208 and move the card reader to a more convenient height/location.

In another non-limiting example, the set of cameras 216 captures image data associated with a cart 222 associated with the user 206. The computing device (not shown) may analyze the image data to determine if the cart 222 is a motorized cart on which the user is sitting or riding. If the user is sitting or riding on a motorized cart, the detachable mounting device 204 releases the outer mounting ring assembly 212 enabling the user 206 to detach the card reader 208 and move the card reader to a more convenient height/location for utilization while the user is sitting. In this manner, the user 206 is not required to stand or get off the motorized cart to utilize the card reader 208.

In yet another example, the set of cameras 216 may generate image data associated with a mobility aid device 224 associated with the user 206. A mobility aid device is a device to assist one or more users with moving from one location to another location. A mobility aid device 224 may include a wheelchair, a walker, a crutch, etc. If the image data generated by the set of cameras 216 indicates the user 206 is utilizing a wheelchair or other mobility aid device, the outer mounting ring assembly 212 may be released to permit the user 206 to detach the card reader 208 from the point of attachment 214. This enables the user to more easily utilize the card reader 208 while continuing to utilize the mobility aid device 224.

The set of sensors 202 in other examples includes a set of microphones 218 enabling voice recognition and/or verbal commands. In this example, the user 206 and/or the user 224 may verbally request the detachable mounting device release the card reader 208 enabling the card reader to be moved away from the point of attachment 214.

The set of sensors 202 may include the set of RFID tag readers 220. The one or more RFID tag readers may be attached to the POS fixture, attached to a portion of a ceiling, attached to a portion of a wall or shelf, or attached to the detachable mounting device. The set of RFID tag readers 220 may receive RFID tag data from an RFID tag 226 attached to the cart 222, an RFID tag 228 attached to the mobility aid device 224, or any other device associated with the user 206. If the RFID tag data generated by the RFID tags indicates the user is utilizing a motorized cart, a wheelchair, or other mobility aid device, the detachable mounting device releases the outer mounting ring assembly 212.

In yet another example, the cart 222 or the mobility aid device 224 may include a beacon device 230. The beacon device 230 is a short-range data transmission device, such as, but not limited to, a BLUETOOTH brand communication module. A beacon receiver 232 receives the signal transmitted by the beacon device 230 indicating that the outer mounting ring assembly 212 should be released for the user 206. The beacon receiver 232 in this example receives the signal when the beacon receiver 232 is within close range of the beacon device 230.

A user 224 associated with the POS fixture 210 in another example may use a manual release control 234 to release the outer mounting ring assembly 212. In this example, if the user 224 is cashier or other authorized personnel, the user 224 may determine that the user 206 would prefer to detach the card reader 208 for greater convenience, the user 224 may press or select the manual release control 234 to release the card reader 208 and attached outer mounting ring assembly 212 enabling the user 206 to adjust the location of the card reader to a more convenient height for completing a transaction.

In some examples, when the user 206 has completed the transaction, the user 206 aligns the outer mounting ring assembly over a threaded receiver 236. The threaded receiver 236 in some examples includes a receiver device for gripping, clamping, or locking onto a connector device associated with the outer mounting ring assembly 212 coupled to the card reader 208. The threaded receiver 236 latches or locks onto the connector device to lock the outer mounting ring assembly to the POS fixture at the point of attachment 214. The threaded receiver 236 in this example may include a threaded receiver member capable of coupling to a grooved connector member on the outer mounting ring assembly 212.

In some non-limiting example, the grooved connector member on the outer mounting ring assembly 212 is aligned over the threaded receiver and turned to lock the outer mounting ring assembly 212 onto the threaded receiver. In one example, the outer mounting ring assembly 212 is turned counter-clockwise to release the outer mounting ring assembly 212 from the threaded receiver 236. In other examples, the outer mounting ring assembly 212 is turned clockwise to release the outer mounting ring assembly 212 from the threaded receiver.

In other examples, a user aligns the outer mounting ring assembly 212 over the threaded receiver device and turns the outer mounting ring assembly 212 counter-clockwise or clockwise to lock the outer mounting ring assembly 212 to the threaded receiver. Locking the outer mounting ring assembly 212 onto the threaded receiver manually secures the outer mounting ring assembly 212 to the POS fixture 210.

The user 206 may push down and/or turn the outer mounting ring assembly 212 to reattach the card reader 208 and outer mounting ring assembly 212 back onto the POS fixture 210 at the original point of attachment 214. In some examples, the user turns the outer mounting ring assembly 212 substantially ninety degrees clockwise to return the outer mounting ring assembly back to the locked configuration. In other examples, the user pushes the outer mounting ring assembly 212 down onto the threaded receiver device to return it to the locked configuration. In still other examples, the user 206 may simply let go or release the outer mounting ring assembly 212 to trigger the detachable mounting device 204 to automatically retract the outer mounting ring assembly back to the locked position at the point of attachment 214.

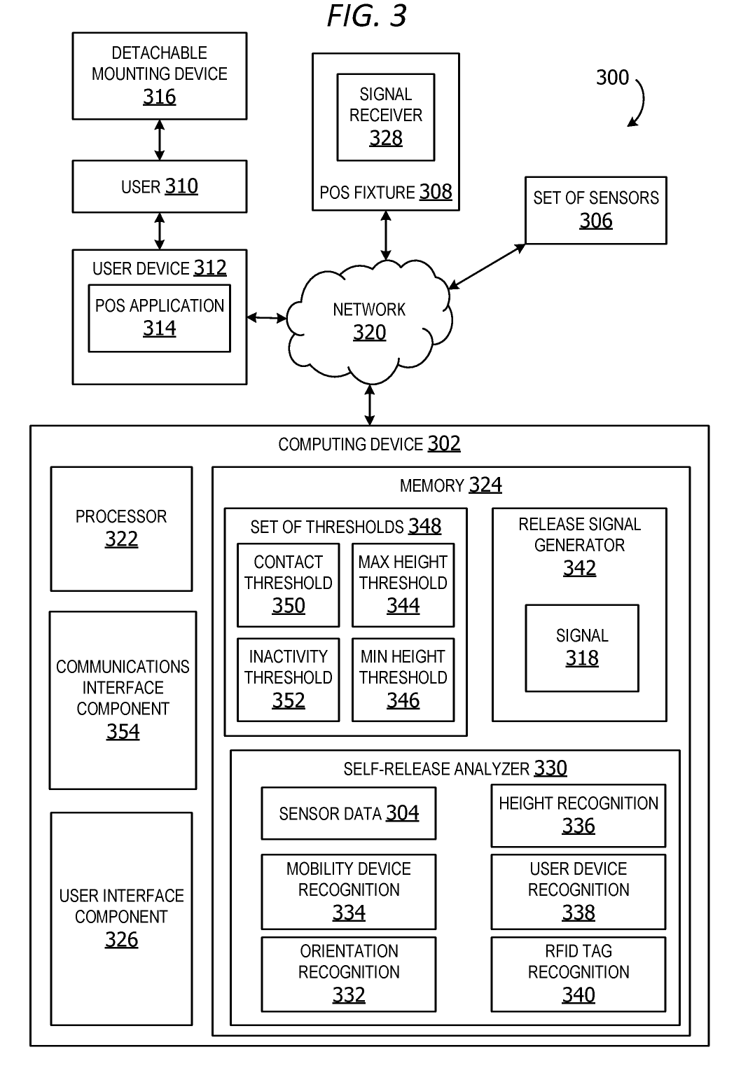

FIG. 3 is an exemplary block diagram illustrating a computing device for analyzing sensor data. In the example of FIG. 3, a detachable card reader mounting system 300 optionally includes the computing device 302 for analyzing sensor data 304 generated by a set of sensors 306 associated with a POS fixture 308. In some examples, computing device 302 may be an illustrative example of controller 209 in FIG. 2. The set of sensors 306 includes one or more sensor devices, such as, the set of sensors 202 in FIG. 2. A sensor in the set of sensors 306 in this non-limiting example may include an RFID tag reader, an image capture device (camera), a microphone, a beacon receiver, a pressure sensor, a weight sensor, or any other type of sensor device.

The POS fixture 308 is a fixed POS structure associated with one or more payment devices, such as a card reader and/or a cash register. The POS fixture 308 may be a fixture such as POS fixture 102 in FIG. 1 and POS fixture 210 in FIG. 2.

The set of sensors 306 generate the sensor data regarding a user 310, a user device 312, the POS fixture 308, a shopping cart, a mobility aid device, or other characteristic associated with a user such as the user 108 in FIG. 1 or the user 206 in FIG. 2. The user 310 may be a customer, shopper, guest, or other person attempting to complete a financial transaction, such as make a payment, via the POS fixture 308.

The user device 312 represents any device executing instructions (e.g., as application programs, operating system functionality, or both) to implement the operations and functionality associated with the user device 312. The user device 312 may include a mobile computing device or any other portable device associated with the user 310. In some examples, the user device 312 includes a mobile telephone, laptop, tablet, computing pad, netbook, gaming device, and/or portable media player.

In some examples, the user device 312 includes a POS application 314 executing on the user device 312. The POS application 314 may transmit a release signal to the detachable mounting device 316, such as the signal 318. The POS application 314 sends the release signal to a signal receiver 328 associated with the POS fixture 308 to automatically trigger the detachable mounting device 316 associated with the POS fixture to release the outer mounting ring assembly connected to at least one card reader to enable the user 310 to remove the at least one card reader from the point of attachment on the POS fixture 308. The signal may be transmitted to the detachable mounting device via a network 320.

The signal receiver 328 may include any type of device for receiving a signal, such as, but not limited to, an RFID tag receiver, a communications interface component, a beacon receiver, a BLUETOOTH™ device, or any other type of device for receiving a signal. The signal receiver 328 in this example is attached to the POS fixture 308. In other examples, the signal receiver 328 may be embedded within the detachable mounting device 316.

The network 320 may be implemented by one or more physical network components, such as, but without limitation, routers, switches, network interface cards (NICs), and other network devices. The network 320 in some examples is a network enabling communications between the user device 312, the detachable mounting device 316, the set of sensors 306, and/or the computing device 302. The network 320 may include, without limitation, a local area network (LAN), a wide area network (WAN), a wireless (Wi-Fi) network, or any other type of network. In this example, the network 116 is a Wide Area Network (WAN) accessible to the public, such as the Internet.

The computing device 302 is a device executing instructions (e.g., as application programs, operating system functionality, or both) to implement the operations and functionality associated with the user device 312. In this example, the computing device 302 is a server. In other examples, the computing device 302 may include a mobile computing device or any other portable device associated with the user 310. The computing device 302 on still other examples may be a desktop personal computer, kiosk, tabletop device, industrial control device. Additionally, the computing device may represent a group of processing units or other computing devices. In yet other examples, the computing device 302 may be implemented by a cloud server.

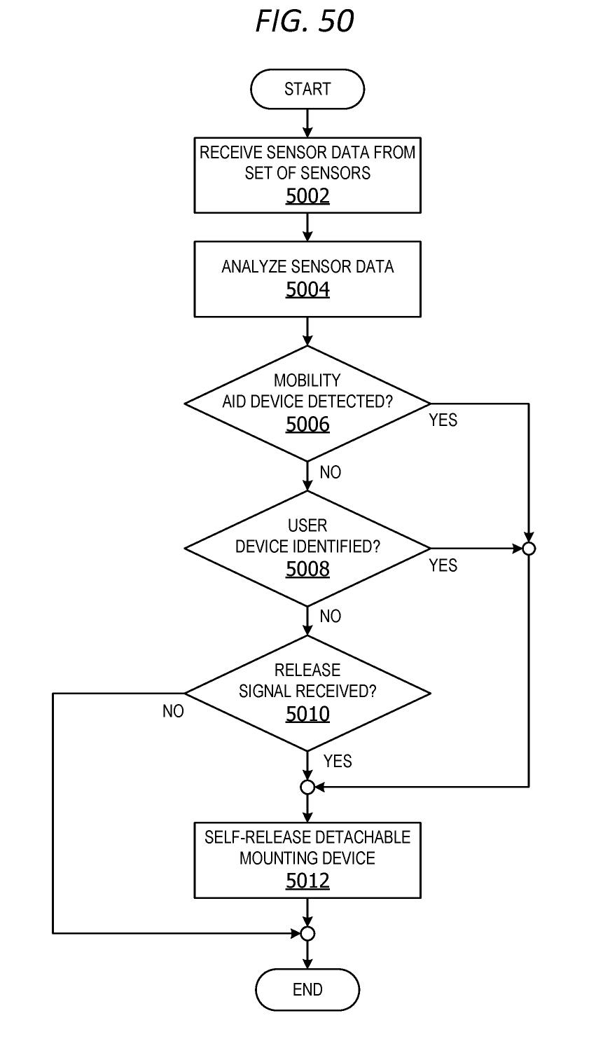

In some examples, the computing device 302 has at least one processor 322, a memory 324, and at least one user interface 326. The processor 322 includes any quantity of processing units, and is programmed to execute computer-executable instructions. The instructions may be performed by the processor 322 or by multiple processors within the computing device 302, or performed by a processor external to the computing device 302. In some examples, the processor 302 is programmed to execute instructions such as those illustrated in FIG. 50.

The computing device 302 further has one or more computer readable media such as the memory 324. The memory 324 includes any quantity of media associated with or accessible by the computing device 302. The memory 324 may be internal to the computing device 302 (as shown in FIG. 3), external to the computing device (not shown), or both (not shown).

The memory 324 stores data, such as one or more applications. The applications, when executed by the processor, operate to perform functionality on the computing device 302. The applications may communicate with counterpart applications or services such as web services accessible via the network 320. For example, the applications may represent downloaded client-side applications that correspond to server-side services executing in a cloud.

The memory in some examples stores a self-release analyzer 330. The self-release analyzer 330 analyzes the sensor data 304 to determine whether to automatically self-release the outer mounting ring assembly of the detachable mounting device 316. In one example, the self-release analyzer 330 analyzes the sensor data 304 using orientation recognition 332 data to determine an orientation of the user 310 as the user 310 approaches the POS fixture 308. If the self-release analyzer 330 determines that an orientation of the user indicates the user is in a sitting position, a release signal generator 342 sends the release signal 318 to the signal receiver 328 to trigger automatic release of the outer mounting ring assembly.

In another example, the self-release analyzer 330 analyzes the sensor data 304 using mobility device recognition 334 to determine a type of mobility device recognition associated with the user 310. For example, if the self-release analyzer 330 determines that the user is using a mobility device, such as a wheelchair, motorized cart, or walker, the release signal generator 342 sends the release signal 318 to the signal receiver 328 to trigger automatic release of the outer mounting ring assembly.

The self-release analyzer 330, in another example, analyzes the sensor data 304 using height recognition 336 data to determine a height of the user 310. If the height of the user is greater than a maximum (MAX) height threshold 344 or less than a minimum (MIN) height threshold 346, the release signal generator 342 sends the release signal 318 to the signal receiver 328 to trigger automatic release of the outer mounting ring assembly.

The self-release analyzer 330 analyzes the sensor data 304 in still other examples using user device recognition 338 to determine whether the user device 312 associated with the user 310 is recognized. The user device is recognized if the user device is executing the POS application 314. For example, the POS application 314 may enable the user 310 to log-on to the detachable card reader mounting system using a user name and password, or other identification data indicating the user has indicated a preference for utilizing a detached card reader rather than a card reader in a fixed position on the POS fixture 308. If the self-release analyzer 330 determines that the user device 312 is recognized, the release signal generator 342 sends the release signal 318 to the signal receiver 328 to trigger automatic release of the outer mounting ring assembly.

In another example, the self-release analyzer 330 analyzes the sensor data 304 using RFID tag recognition 340 data to retrieve data associated with an RFID tag attached to a mobility aid device, the user device 312, and/or a shopping cart. The RFID tag data may indicate that the user prefers to detach the card reader for completion of a payment transaction. If the self-release analyzer 330 determines that the RFD tag data indicates the card reader should be released, the release signal generator 342 sends the release signal 318 to the signal receiver 328 to trigger automatic release of the outer mounting ring assembly coupled to the card reader.

In yet another example, the self-release analyzer 330 analyzes the sensor data 304 using a set of thresholds 348. The set of thresholds 348 may include a contact threshold 350. The contact threshold 350 indicates a threshold length of time during which a user is in contact with a set of contact points associated with the detachable mounting device. For example, if the user places their hand on one or more contact points for the contact threshold 350, the release signal generator 342 sends the release signal 318 to the signal receiver 328 to trigger automatic release of the outer mounting ring assembly.

In this example, the release signal generator 342 runs on the computing device 302. In other examples, the release signal generator 342 may be a component executing on the user device 312 or a component executing on the detachable mounting device 316, a cloud server, or a payment device associated with the POS fixture 308.

Following release of the outer mounting ring assembly, the detachable mounting device 316 automatically retracts the outer mounting ring assembly back to the point of attachment on the POS fixture 308 if the card reader does not receive any user input for an inactivity threshold 352 time. In still other examples, the detachable mounting device 316 automatically retracts the outer mounting ring assembly back to the point of attachment on the POS fixture 308 if the user 310 releases or drops the detached card reader and attached outer mounting ring assembly. The detached card reader and attached outer mounting ring assembly may be retracted via a retractor device and a set of retractable cables attached to the card reader at one end and a cable housing attached to the POS fixture 308 at the opposite end.

The computing device 302 may optionally include a communication interface component 354. In some examples, the communications interface component 354 includes a network interface card and/or computer-executable instructions (e.g., a driver) for operating the network interface card. Communication between the computing device and other devices may occur using any protocol or mechanism over any wired or wireless connection. In some examples, the communications interface component 354 is operable with short range communication technologies such as by using near-field communication (NFC) tags.

In some examples, the user interface component 326 includes a graphics card for displaying data to the user and receiving data from the user. The user interface component 326 may also include computer-executable instructions (e.g., a driver) for operating the graphics card. Further, the user interface component 326 may include a display (e.g., a touch screen display or natural user interface) and/or computer-executable instructions (e.g., a driver) for operating the display. The user interface component 326 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

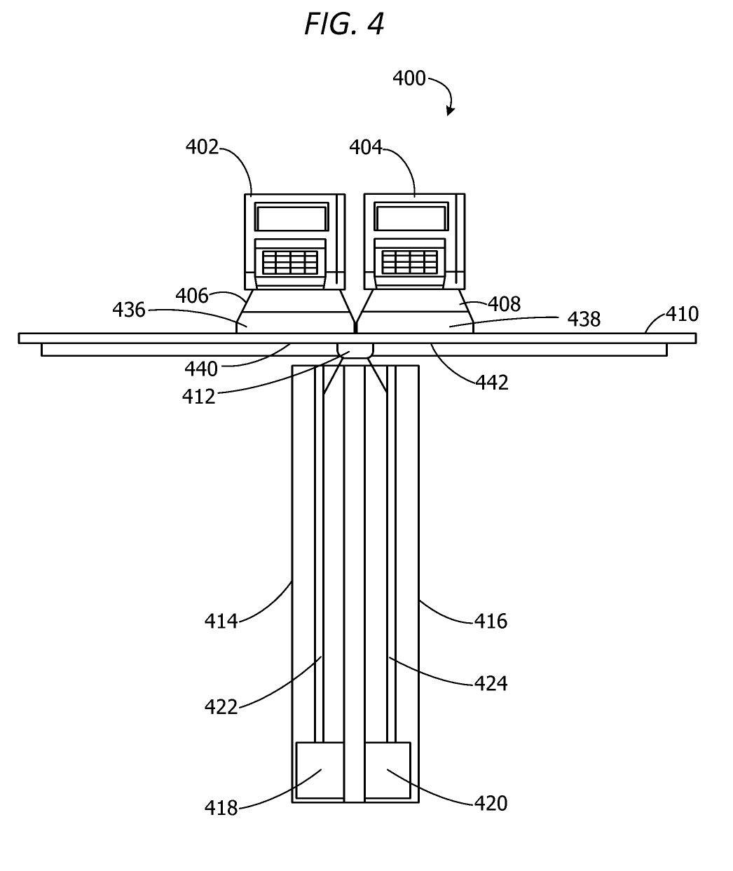

FIG. 4 is an exemplary front elevation view of a set of detachable card reader mounting devices 400. A set of mounted card reader devices in this example includes a first card reader 402 and a second card reader 404 attached to at least one detachable mounting device. The card reader 402 and/or the card reader 404 are payment devices, such as, but not limited to, the card reader 106 in FIG. 1 and/or the card reader 208 in FIG. 2.

In this example, the first card reader 402 is attached to a first card reader stand 406 removably attached to a portion of a substantially flat surface associated with a member 410 of a POS fixture at a point of attachment 440. The detachable card reader stand 406 in this example includes a receiver device 436 coupled to a portion of the member 410 of the POS fixture.

The member 410 in this example is a counter top. In other examples, the member 410 may be a shelf, a ledge, a cabinet, a table top, a desk top, or any other part of a POS fixture.

A first set of cables 422 is attached to a first end of the first card reader 402. The first set of cables are threaded through a grommet 412 embedded within and through the member 410 (counter top). The first set of data cables run through the grommet into a first cable housing 414. In this example, the first set of cables attached to the first card reader 402 are retracted inside the cable housing via a set of one or more weights 418 attached to the second end of the set of data cables at a bottom portion of the first cable housing 414. The set of cables are retracted while the first card reader is in a locked configuration at the point of attachment on the POS fixture.

When the card reader 402 is released, the set of weights 418 are disengaged to permit the set of data cables to extend out of the first cable housing 414. As a user pulls the card reader 402 away from the member 410, the set of data cables extend out of the first cable housing enabling the card reader 402 to be moved away from the POS fixture while anchoring the card reader to the POS fixture via the set of cables.

The second card reader 404 in this non-limiting example is attached to a second card reader stand 408 removably attached to a portion of the member 410 of the POS fixture. The detachable card reader stand 408 in this example includes a receiver device 438 coupled to a portion of the member 410 of the POS fixture.

A second set of cables 424 is attached to a first end of the second card reader 404. The second set of cables are threaded through the grommet 412 embedded within and through the member 410 (counter top). The second set of data cables 424 are threaded through the grommet into a second cable housing 416 located beneath the surface of the counter top.

A weight is attached to each cable in the set of cables in some examples. In this example, there are two cables, a communications cable and a security cable. The cables are threaded through the grommet and separated into separate tubing within the cable housing. The communications cable retracts into a first tube while the security cable retracts into a separate second tube. The cables in the set of retractable cables extend and retract together without tangling because each cable retracts into its own tube.

In another non-limiting example, each cable in a set of cables is housed in a different cable housing. The first cable housing 414 may be a housing for a single data communications cable and the second cable housing 416 may be a housing for a single security cable connected to a single mounted card reader device, such as the mounted card reader device 402, for example.

In this example, the second set of cables 424 attached to the second card reader 404 is retracted inside the cable housing 416 via a set of one or more weights 420 attached to the second end of the set of data cables at a bottom portion of the second cable housing 416. The set of cables are retracted while the second card reader is in a locked configuration at the second point of attachment 442 on the POS fixture.

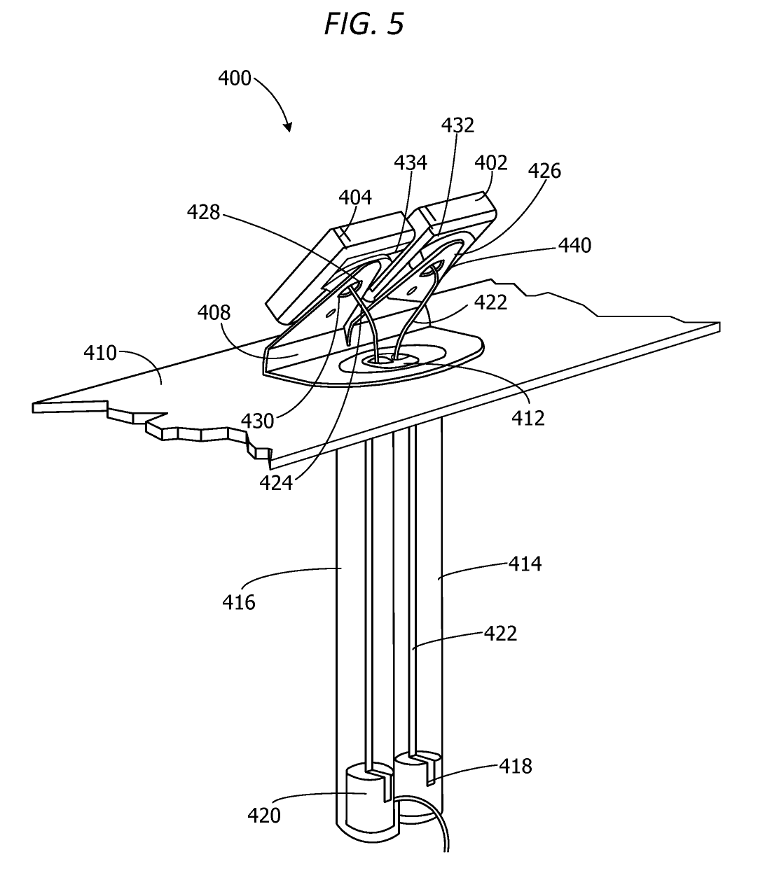

FIG. 5 is an exemplary back perspective view of the detachable set of detachable card reader mounting devices 400. The grommet 412 in this non-limiting example is a grommet including a divider separating the first set of data cables 422 attached to the first card reader into the first cable housing 414 and separating the second set of data cables 424 attached to the second card reader 404 into the second cable housing 416.

In this example, the first card reader stand 406 includes an outer mounting ring assembly 426 attached to a back 432 of the first card reader 402. The outer mounting ring assembly 426 includes a base plate 426 having an aperture 428 to accommodate the first set of data cables 422. Likewise, the second card reader stand 408 in this example includes an outer mounting ring assembly attached to a back 434 of the second card reader 404. The outer mounting ring assembly includes a base plate 428 having an aperture 430.

The second set of cables 424 attached to the second card reader 404 is threaded through the aperture and into the grommet 412. The grommet 412 in some examples includes a divider inside the grommet which allows multiple cables to feed in and out through single hole/aperture.

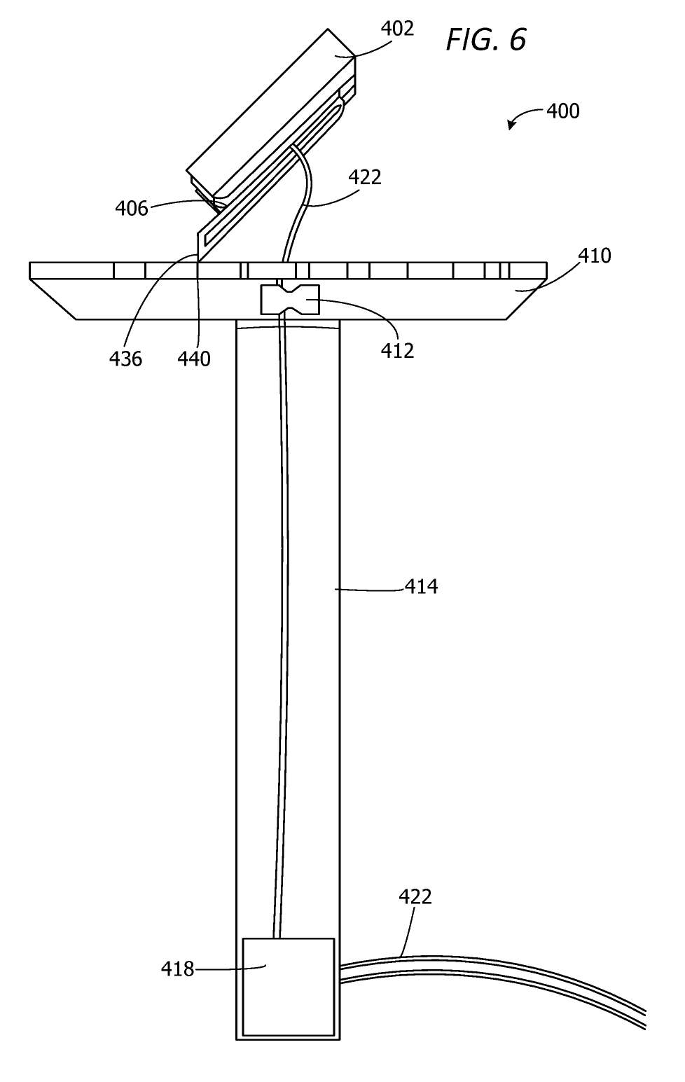

FIG. 6 is an exemplary side elevation view of the set of detachable card reader mounting devices 400. The detachable card reader stand 406 in this example includes a receiver device 436 coupled to a portion of the member 410 of the POS fixture. When the detachable card reader stand 406 is locked onto the receiver device 436, the first card reader 402 is held to the member 410 by the receiver device 436 such that the first card reader 402 is held in a fixed and stable orientation to the point of attachment 404. When the receiver device 436 is unlocked (released), the detachable card reader stand and attached first card reader 402 may be removed from the point of attachment 404 and held in a user's hand, placed in a user's lap, or otherwise removed to a higher or lower height for increased convenience and ease of accessibility for the user.

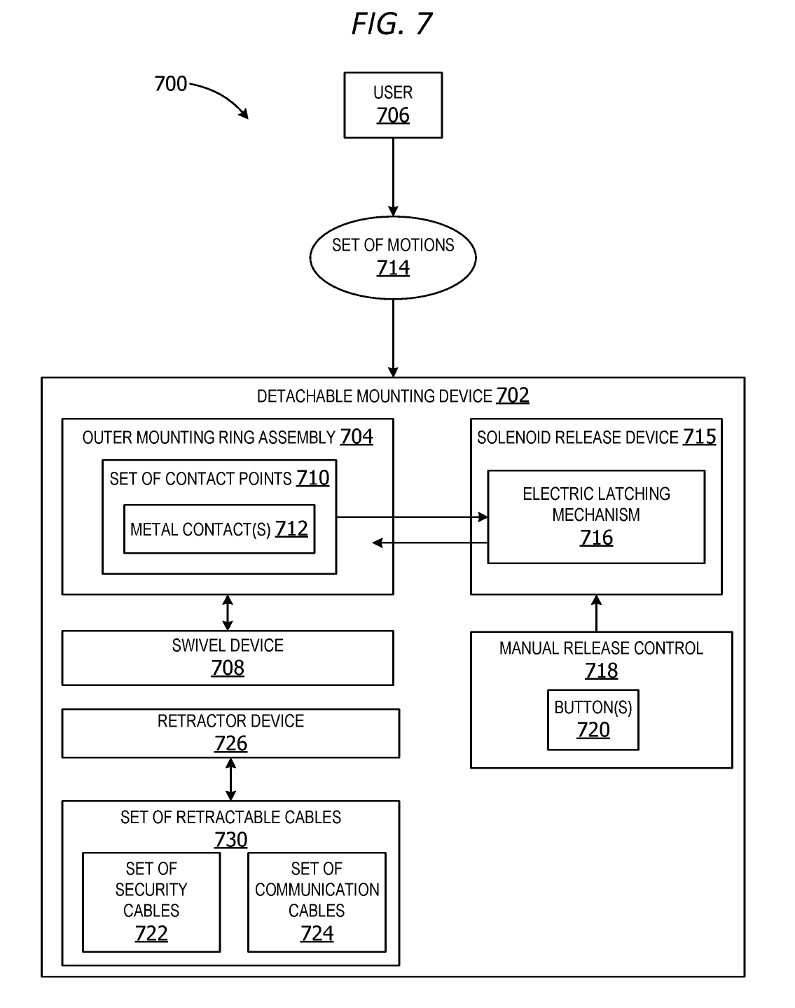

FIG. 7 is an exemplary block diagram illustrating a system 700 including a detachable mounting device 702 for a card reader. The detachable mounting device 702 in this example includes an outer mounting ring assembly 704, such as the outer mounting ring assembly 212 in FIG. 2. A swivel device 708 in some examples enables a user 706 to swivel or tilt the detachable mounting device forward or backward at an angle for improved access to a card reader attached to the detachable mounting device 702. The swivel device pivots on an axel or other pivot point to permit a portion of the detachable mounting device 702 to be tilted forward or backward.

In some examples, the user 706 may perform a set of motions 714 to detach or re-attach the outer mounting ring assembly 704 with a coupled card reader from a receiver device. For example, the set of motions 714 may include touching, pressing, squeezing, pushing, turning or holding one or more contact points on the detachable mounting device 702.

The outer mounting ring assembly 704 for example may include a set of contact points 710. A contact point is an area comprising a touch sensor or other device for detecting contact by a user's finger, hand, or other appendage. If the user touches or contacts one or more of the contact points for a contact threshold time, such as the contact threshold 350 in FIG. 3, the receiver device releases the outer mounting ring assembly 704. The set of contact points 710 in some examples includes one or more metal contact(s) 712.

The set of motions in other examples may include aligning the outer mounting ring assembly 704 over the receiver device. The receiver device in this example is a solenoid release device 715 including an electric latching mechanism 716. In other examples, the receiver device may include a threaded receiver, such as a receiver device associated with the threaded receiver 236 in FIG. 2.

In still other examples, the set of motions 714 may include turning or rotating the outer mounting ring assembly 704 clockwise or counter-clockwise. In one example, the set of motions 714 includes turning the outer mounting ring assembly 704 counter-clockwise ninety degrees to release the outer mounting ring assembly 704. In one example, the set of motions 714 includes aligning the outer mounting ring assembly 704 over the receiver device and turning the outer mounting ring assembly 704 clockwise ninety degrees to lock the outer mounting ring assembly 704.

In another example, the detachable mounting device 702 includes a manual release control 718. The manual release control 718 may include one or more button(s) 720. In other examples, the manual release control 718 may be a graphical user interface control on a display screen or other output device, a physical switch, a touch sensor, a temperature sensor, or other control. When the user 706 engages the manual release control 718, the solenoid release device 715 disengages an electric latching mechanism 716 to release the outer mounting ring assembly 704 with the attached card reader from the POS fixture. When the outer mounting ring assembly 704 is returned to the receiver device, the electric latching mechanism 716 re-engages a lock or latch to secure the outer mounting ring assembly 704 to the POS fixture point of attachment.

The electric latching mechanism 716 in some examples can detect when a mounted card reader device is aligned or placed back on the fixed portion of the detachable mounting device. The electric latching mechanism 716 in these examples automatically engages at least one tab or lock to secure the mounted card reader device back on the POS fixture when the mounted card reader is returned to the point of attachment on the POS fixture.

In some examples, the detachable mounting device 702 in other examples include a set of retractable cables 730, such as the first set of cables 422 and/or the second set of cables 424. In this example, the set of retractable cables 730 includes a set of security cables 722 and a set of communications cables 724. A security cable in the set of security cables 722 is a security cable anchoring the card reader attached to the outer mounting ring assembly 704 to the POS fixture to prevent the card reader from being completely separated from the POS fixture.

A communication cable in the set of communications cables 724 may include one or more data communication cables for transmitting data from the card reader to one or more other computing devices, such as the computing device 302 in FIG. 3. A retractor device 726 in some examples retracts the set of retractable cables 730 when the detachable mounting device is in a locked configuration. The retractor device 726 releases the set of retractable cables 730 increasing slack in the cables when the detachable mounting device 702 is in an unlocked (released) configuration enabling the set of retractable cables 730 to extend out of a cable housing enclosing the set of retractable cables 730.

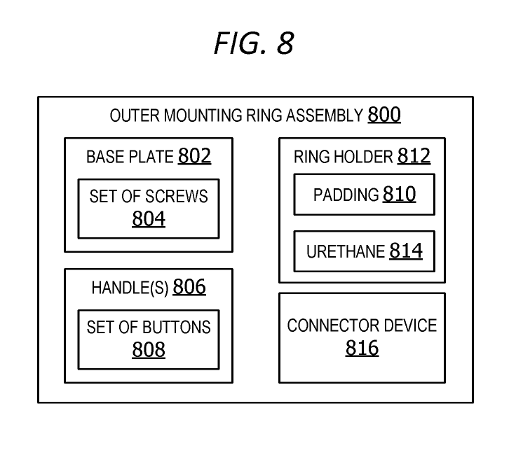

FIG. 8 is an exemplary block diagram illustrating an outer mounting ring assembly. The outer mounting ring assembly 800 in this example includes a base plate 802 and a set of one or more screws 804. The base plate in this example is secured to a back face of a card reader via a set of screws 804. However, in other examples, the base plate 802 may be attached to a card reader using rivets, bolts, welding, glue, or any other type of device for attaching a card reader to the base plate 802.

The outer mounting ring assembly 800 may optionally include a set of one or more handles 806. A user may hold the outer mounting ring assembly 800 via the handle(s) 806. The handle(s) 806 may include a set of buttons 808. The set of buttons 808 may include a manual release button for releasing the outer mounting ring assembly 800 from the POS fixture, such as the manual release control 718 in FIG. 7.

The outer mounting ring assembly 800 in other examples includes padding 810 covering the handle(s) 806. In other examples, the outer mounting ring assembly 800 includes a ring holder 812. The ring holder 812 attaches to the base plate 802. The ring holder 812 may be a urethane 814 encapsulated ring holder 812.

In another example, the ring holder 812 may including padding 810 around the outside surface of the ring holder 812. The padding 810 optionally provides improved comfort and better grip for user's holding the outer mounting ring assembly 800 via the ring holder and/or the handle(s) 806.

In still another example, a connector device 816 is provided. The connector device 816 may be configured to attached to a receiver device, such as the receiver device associated with the threaded receiver 236 in FIG. 2. and/or the solenoid release device 715 in FIG. 7.

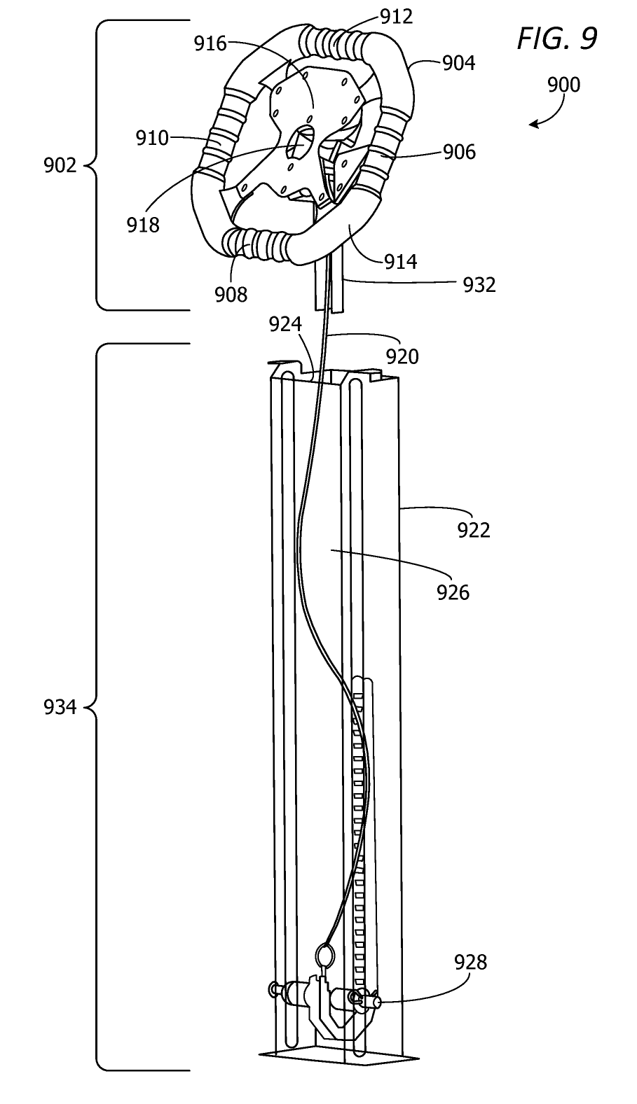

FIG. 9 is an exemplary perspective view of a detachable mounting device for a card reader. The detachable mounting device 900 includes an outer mounting ring assembly 902. The outer mounting ring assembly 902 in this non-limiting example includes a ring holder 904, such as the ring holder 812 in FIG. 8. The ring holder 904 in this non-limiting example is a urethane encapsulated ring.

The ring holder 904 may be padded 914. The padding protects users from any sharp or rough members associated with the ring holder. The padding may also reduce slippage and improve a user's ability to grip the ring holder 904.

A base plate 916 attached to the ring holder 904 includes attaching means for attaching a card reader to the base plate. The base plate 916 in this non-limiting example is a universal card reader adapter plate for attaching a card reader to the outer mounting ring assembly 902. When a card reader is attached to the base plate 916, the card reader in some examples, is encircled by the ring holder.

The ring holder 904 may optionally include a set of handles, such as handle(s) 806 in FIG. 8. In some examples, the handles 906, 908, 910, and/or 912 protrude beyond the card reader enabling the user to grasp or hold the carder reader attached to the outer mounting ring assembly 902 via one or more of the handles 906, 908, 910, and/or 912.

The base plate 916 in this example defines an aperture 918. The aperture 918 is a hole or channel through the base plate 916 having a diameter equal to or greater than a diameter of a set of retractable cables 920. One end of the set of retractable cables 920 are attached to a base of the card reader (not shown) mounted onto the outer mounting ring assembly 902. The set of retractable cables 920 are threaded through the aperture 918, pass through a protective shroud 932, and retracts into a cable housing 922. The cable housing 922 is an under-counter containment fixture for enclosing the set of retractable cables.

The outer mounting ring assembly 902 in some examples includes the shroud 932. The shroud 932 encloses a portion of the set of retractable cables and protects the set of retractable cables 920 when the outer mounting ring assembly 902 is detached from the POS fixture.

A fixed portion 934 of the detachable mounting device 900 in this example includes a cable housing 922. The fixed portion 934 is a portion of the detachable mounting device 900 that is embedded or non-removably attached to a portion of the POS fixture. The cable housing 922 is a tube, pipe, or channel enclosing an open space 926 configured to enclose the set of retractable cables 920.

In this non-limiting example, the set of retractable cables include a cable retractor device 924 attached to a weight rode 928. The retractor device 924 slides upward to increase slack for the set of retractable cables 920 and slide downward to retract the set of retractable cables 920.

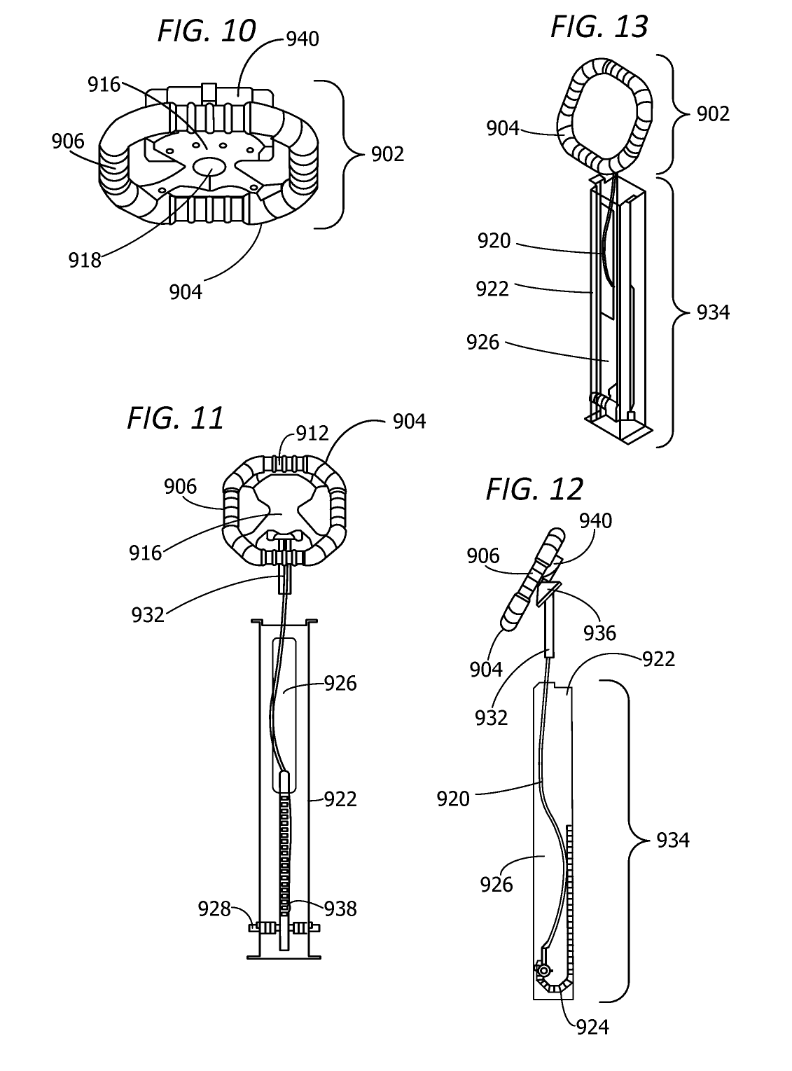

FIG. 10 is an exemplary perspective view of an outer mounting ring assembly. The outer mounting ring assembly 902 in this example includes a ring holder 904 attached to a base plate 916 and a latching mechanism 940 coupled to a back face of the outer mounting ring assembly 902. The latching mechanism 940 is a connector device for latching or locking onto a receiver device, such as the threaded receiver 236 in FIG. 2 and/or the solenoid release device 715 in FIG. 7. The latching mechanism 940 may be a connector device such as the connector device 816 in FIG. 8. The latching mechanism 940 may be aligned with a receiver device on the fixed portion 934 of the detachable mounting device 900.

FIG. 11 is an exemplary front view of a detachable mounting device. The cable housing 922 includes a set of shaft collars 938 for one or more weights associated with the weight bar 928.

FIG. 12 is an exemplary side view of a detachable mounting device. The outer mounting ring assembly 902 in this example includes the latching mechanism 940 and a swivel device 936. The swivel device 936 is a device enabling the outer mounting ring assembly 902 to pivot forward and backward on an axis.

The outer mounting ring assembly 902 in this non-limiting example is in an un-locked configuration with the fixed portion 934 of the detachable mounting device 900. In this example, the outer mounting ring assembly 902 has been detached from the cable housing 922. The detached outer mounting ring assembly 902 remains anchored to the cable housing 922 of the fixed portion 934 of the detachable mounting device 900 via the set of retractable cables 920 connecting the card reader to the cable housing 922. In this manner, the user may only move the card reader away from the point of attachment for the length of the set of retractable cables. The user is prevented from taking the card reader or moving the card reader farther away than the length of the set of retractable cables.

FIG. 13 is an exemplary perspective view of a side of a detachable mounting device. The outer mounting ring assembly 902 in this non-limiting example is in a locked configuration with the fixed portion 934 of the detachable mounting device 900. In this example, the latching mechanism 940 is locked to a receiver device associated with the fixed portion 934.

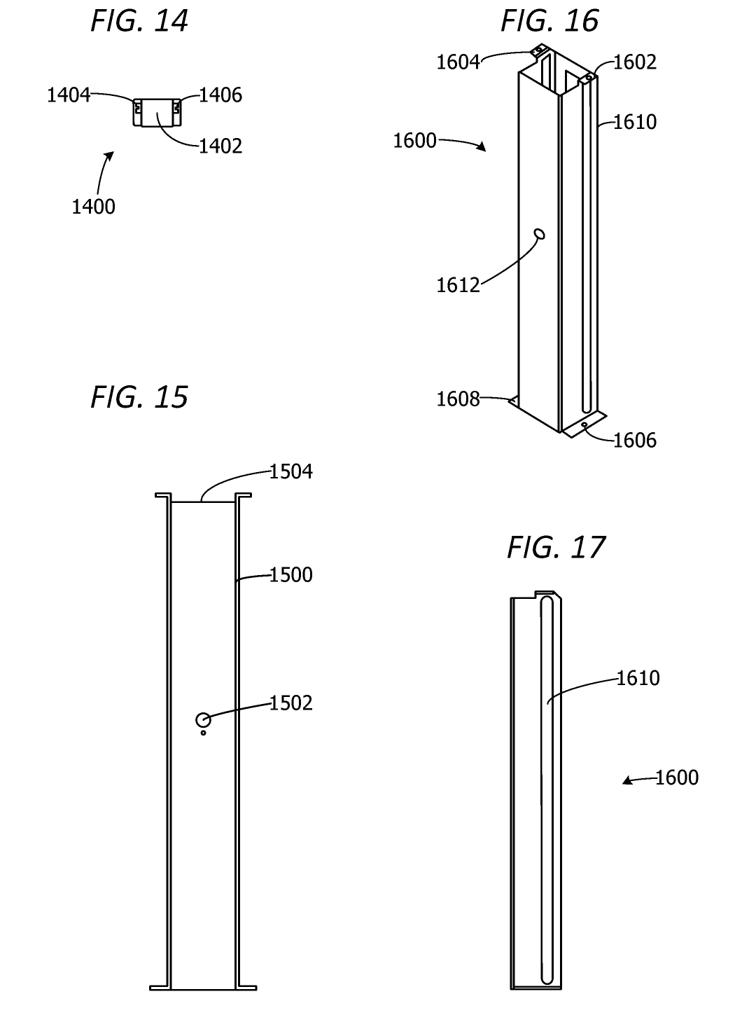

FIG. 14 is an exemplary plan view of a cable housing looking down onto the cable housing from a bird's eye view. The cable housing 1400 defines a cavity 1402 for enclosing a set of retractable cables. The cable housing 1400 may optionally be attached to a counter or other portion of a POS fixture via a set of screws 1404 and/or 1406. In other examples, the cable housing 1400 may be attached via nails, glue, welds, bolts, or any other type of attachment means.

FIG. 15 is an exemplary front cross-sectional view of a cable housing. The cable housing 1500 in this example includes an opening 1504 at a top portion of the cable housing 1500. The set of retractable cables may enter the cable housing via the opening 1504. The opening 1504 provides an entry way into the tube, pipe, or channel enclosing an open space configured to enclose the set of retractable cables.

FIG. 16 is an exemplary perspective view of a cable housing. The cable housing 1600 in some examples includes a set of fixture attachment means 1602, 1604, 1606, and 1608. In one example, the set of fixture attachment means 1602, 1604, 1606, and 1608 includes a set of screws.

The cable housing 1600 in other examples may include a slot 1610 for the weight bar to slide up and slide down along a vertical length of an interior of the cable housing 1600. In this non-limiting example, the set of retractable cables exits the interior open space within the cable housing 1600 via an exit portal 1612 in a front, exterior face of the cable housing 1600.

FIG. 17 is an exemplary side view of a cable housing. The cable housing 1600 in this non-limiting example includes a side-view of a slot 1610 along a vertical length of each side of the cable housing. The slot 1610 is an up and down (vertical) groove or slotted space for an end of a weight bar to slide up and slide down along the vertical length of the cable housing. The slot 1610 may be included in a right side and a left side of the cable housing 1600.

FIG. 18 is an exemplary cross section of a ring holder. The ring holder 1800 in this non-limiting example includes a handle 1802 including ribbing 1804 to reduce slippage and improve a user's ability to comfortably grip the handle 1802. The ring holder defines a hollow space 1806 and 1808 which may be filled with a suitable substance. In this example, the hollow space 1806 and 1808 is filled with urethane. The ring holder may optionally include padding 1810 encapsulating a portion of the ring holder to soften hard surfaces, prevent sharp edges, and increase user comfort while holding or gripping the ring holder 1800.

FIG. 19 is an exemplary plan view of a ring holder. The ring holder 1900 in this example includes a set of adapter plates for mounting a card reader 1902. In this example, the card reader 1902 is attached to the ring holder 1900 via a set of four adapter plates 1904, 1906, 1908, and 1910. In other examples, the card reader 1902 may be attached to a base plate which is mounted to the ring holder 1900 via the set of adapter plates.

In this example, the set of adapter plates includes four adapter plates 1904, 1906, 1908, and 1910. In other examples, the set of adapter plates may include a single adapter plate, two adapter plates, or any other number of adapter plates for securing a card reader to the ring holder.

The ring holder 1900 in this example includes a set of four handles, the handle 1912, handle 1914, handle 1916 and handle 1918. In other examples, the set of handles may include a single handle, a set of two handles, a set of three handles or any other number of handles.

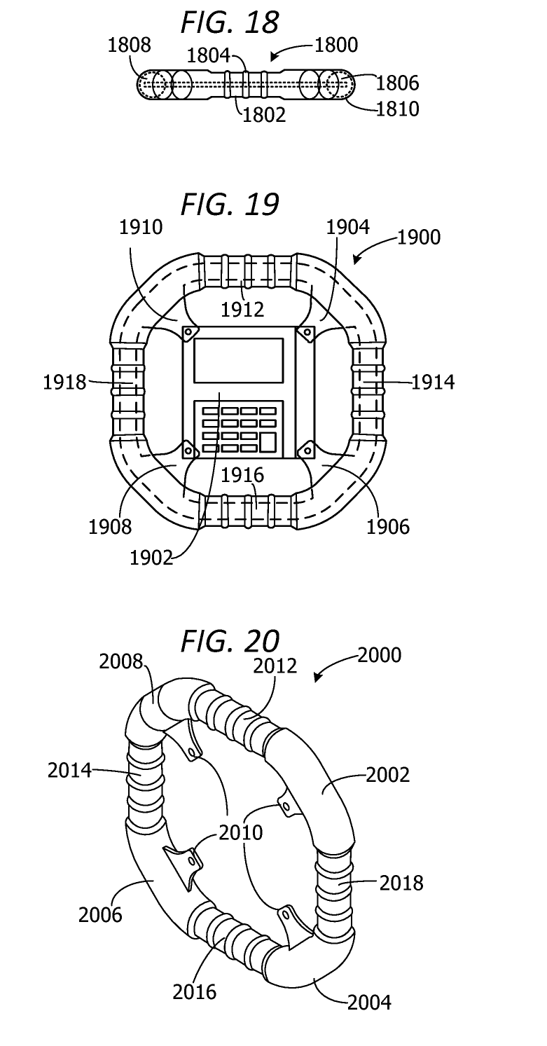

FIG. 20 is an exemplary perspective view of a ring holder. The ring holder 2000 in this example includes a set of padded sections 2002, 2004, 2006, and 2008. The padding on the padded sections in this example protects a user from sharp edges, hard surfaces, or other rough portions of the ring holder 2000.

In some examples, the ring holder 2000 includes a set of adapter plates 2010 for attaching a card reader to the ring holder, such as the adapter plates 1904, 1906, 1908, and 1910 in FIG. 9. The ring holder optionally may also include a set of handles, such as handle 2012, 2014, 2016, and 2018. The handles may be ribbed or padded for increased user comfort.

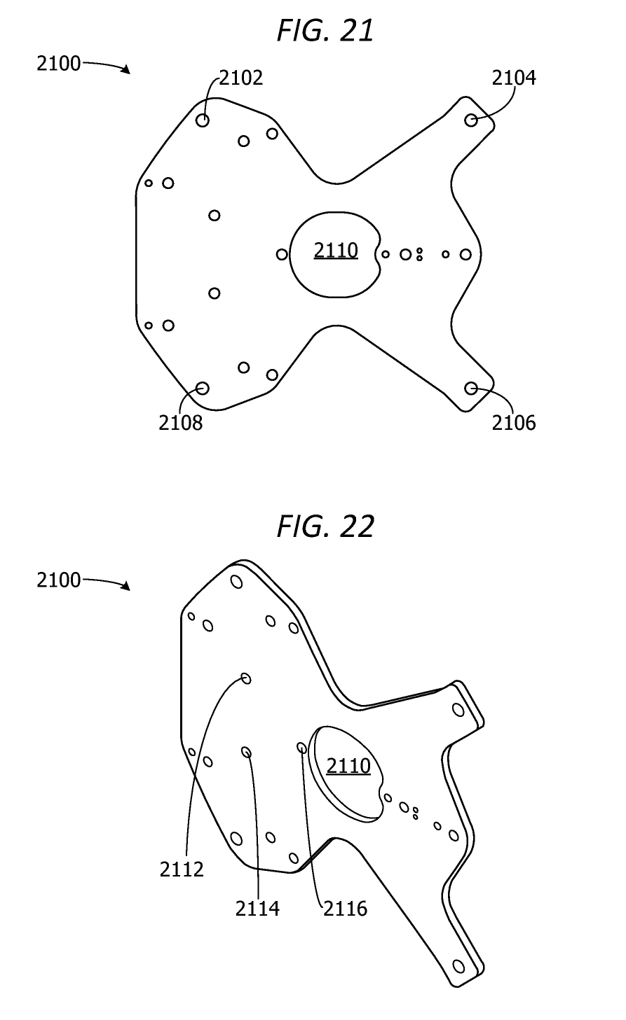

FIG. 21 is an exemplary plan view of a base plate. In this non-limiting example, the base plate 2100 attaches to a ring holder via a set of attachment points 2102, 2104, 2106, and 2108. For example, the base plate 2100 may attach to the set of adapter plates 2010 in FIG. 20 via a set of screws attached at the set of attachment points 2102, 2104, 2106, and 2110. However, the examples are not limited to attaching the base plate to a ring holder using four adapter plates. In other examples, the base plate may be attached to the ring holder using a single adapter plate, as well as two or more adapter plates.

The aperture 2110 is an opening, hole or channel configured to accommodate a set of retractable cables. The aperture 2110 in this example is substantially circular. In other examples, the aperture 2110 may be a square shaped aperture, a rectangular aperture, an ovoid aperture, or any other shape opening having a sufficient diameter to permit the set of retractable cables to pass through the aperture 2110.

FIG. 22 is an exemplary perspective view of a base plate. The base plate 2100 in this example includes a set of attachment points 2112, 2114, and 2116 for attaching a male section of a latching mechanism to the outer mounting ring assembly. In this non-limiting example, the latching mechanism is secured to the base plate via a set of screws or other attachment means at the set of attachment points 2112, 2114, and 2116. However, the examples are not limited to attaching a latching mechanism to the base plate at these three exact attachment points. In other examples, the latching mechanism may be attached to the base plate 2100 via any number of screws or other attachment means secured to the base plate at any number of attachment points located anywhere on the base plate.

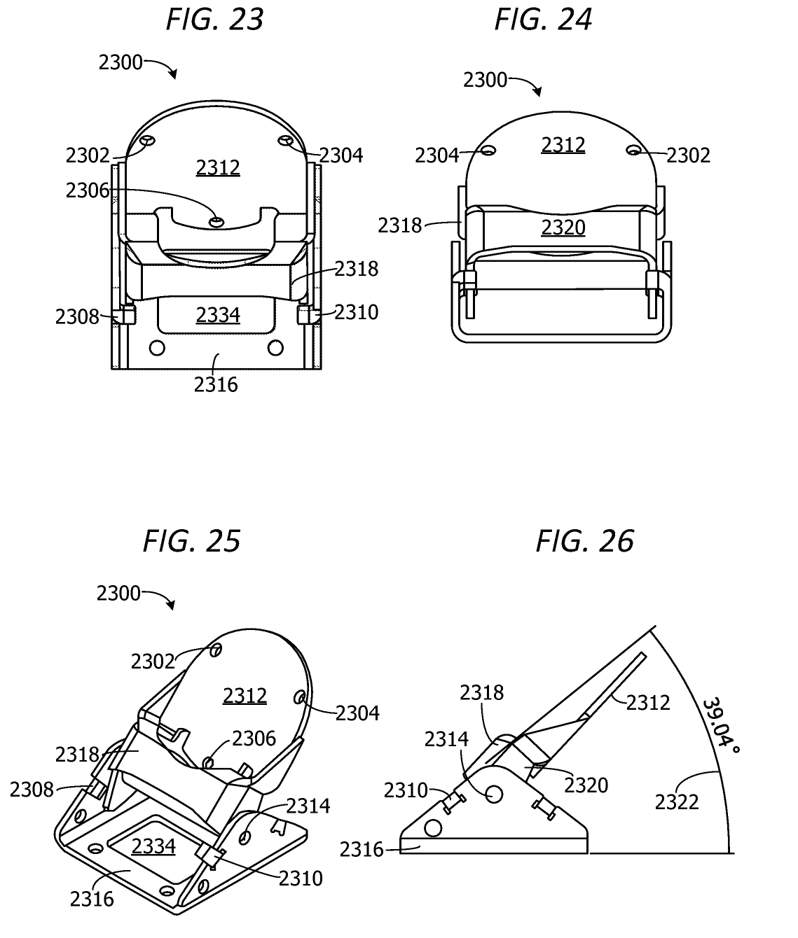

FIG. 23 is an exemplary plan view of a front of a swivel assembly. The swivel device 2300 is a swivel assembly enabling a mounted card reader to be tilted forward and backward to adjust an angle at which the card reader is presented to a user while in a locked configuration. The swivel device 2300 may be a swivel device, such as, but not limited to, swivel device 708 in FIG. 7.

A set of attachment points for attaching the swivel device 2300 to a female receiver of a latching mechanism, in this non-limiting example, includes attachment point 2302, 2304, and/or 2306 in the attachment plate 2312. However, the examples are not limited to three attachment points in the configuration shown in FIG. 23. In other examples, the latching mechanism may attach to the swivel device at one or more attachment points using one or more attachment means at any point on the attachment plate 2312.

In some examples, tabs 2308 and 2310 prevent pinch points on the swivel device 2300. In this example, the swivel device 2300 includes two tabs. In other examples, the swivel device 2300 may include a single tab, as well as three or more tabs.

The swivel device 2300 may include a mounting plate 2316 for mounting the swivel device 2300 to a back face of a base plate of the outer mounting ring assembly, such as the base plate 802 in FIG. 8 or the base plate 2100 in FIG. 21. The mounting plate 2316 defines an aperture 2334. The set of retracting cables in some examples pass through an aperture on the base plate of the outer mounting ring assembly and through the mounting plate aperture 2334 of the swivel assembly 2300.

In other examples, a swivel body 2318 tilts or swivels on an axis point to tilt the attachment plate 2312 forward or backward. This enables a user to tilt a card reader along an axis of rotation when a card reader is mounted to the outer mounting ring assembly attached to the swivel device 2300.

FIG. 24 is an exemplary plan view of a back of a swivel assembly. The swivel device 2300 may include a base member 2320 attaching to a swivel axis point to enable the swivel device 2300 to pivot forward or backward.

FIG. 25 is an exemplary perspective view of a swivel assembly. The swivel device 2300 in this non-limiting example include a mounting plate 2316 for attaching the swivel device 2300 to a counter mounting surface on a portion of a POS fixture.

FIG. 26 is an exemplary plan view of a side of a swivel assembly. The swivel device 2300 in this non-limiting example pivots on a swivel axis 2314 of rotation. The swivel device 2300 in this example swivels along a thirty-nine-degree range of rotation 2322. However, the swivel device 2300 is not limited to a thirty-nine-degree range of rotation. In other examples, the swivel device 2300 may tilt along a greater or less range of rotation.

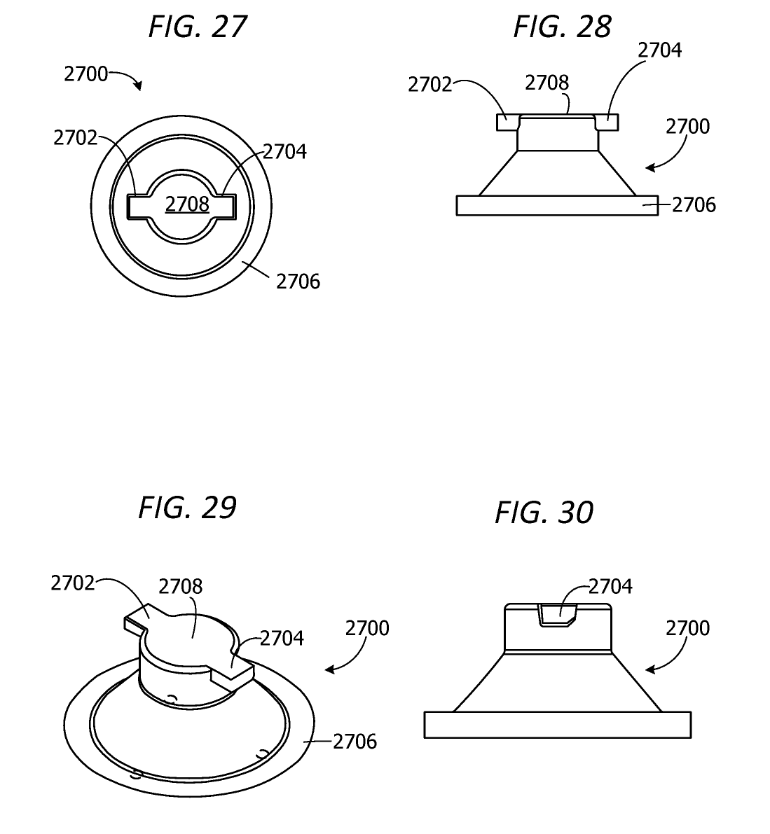

FIG. 27 is an exemplary plan view of a connector portion of a latching mechanism. In this example, the latching mechanism 2700 is a connector portion of the latching mechanism configured to couple to a receiver portion of the latching mechanism. The connector portion of the latching mechanism 2700 includes a set of tabs, such as, but not limited to, tab 2702 and tab 2704. However, the examples are not limited to a pair of two tabs. In other examples, the set of tabs may include a single tab, as well as three or more tabs.

In this non-limiting example, the tabs 2702 and 2704 are interlocking tabs. The tabs 2702 and 2704 extend into internal recesses of the receiver portion of the latching mechanism to lock the detachable mounting device into a locked configuration. In one example, the connector portion of the latching mechanism 2700 includes tabs 2702 and 2704 at a top portion 2708 of the latching mechanism and a base 2706 at a bottom portion of the latching mechanism.

FIG. 28 is an exemplary side view of a connector portion of a latching mechanism. In this example, the connector portion of the latching mechanism 2700 includes tabs 2702 and 2704 at a top portion 2708 of the latching mechanism and a base 2706 at a bottom portion of the latching mechanism.

FIG. 29 is an exemplary perspective view of a connector portion of a latching mechanism. In this non-limiting example, spring pressure from a receiver portion of the latching mechanism forces tabs 2702 and 2704 into internal recesses of the latching mechanism to hold it in place when engaged.

FIG. 30 is an exemplary side view of a connector portion of a latching mechanism 2700. The tabs, such as tab 2704 may be released form an internal recess of the receiver portion of the latching mechanism in some examples by pushing the latching mechanism downward to overcome spring pressure and turning counter-clockwise until the tab 2704 exits through a keyed slot in the receiver portion of the latching mechanism.

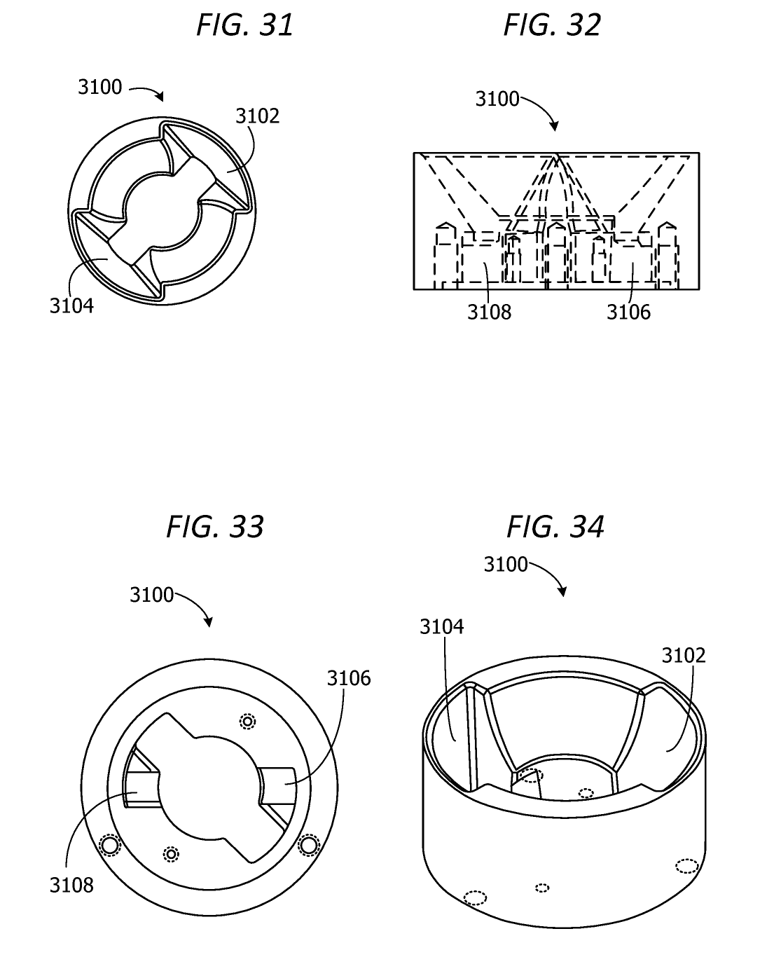

FIG. 31 is an exemplary plan view of a receiver portion 3100 of a latching mechanism. The receiver portion 3100 of the latching mechanism includes a set of keyed slots 3102 and 3104 in this example. The latching mechanism is a device, such as the latching mechanism 2700 in FIG. 27. The keyed slots 3102 and 3104 are provided for release of the tabs associated with the connector portion of the latching mechanism, such as the tabs 2702 and 2704 in FIG. 27.

FIG. 32 is an exemplary cross-section of a receiver portion of a latching mechanism and FIG. 33 is an exemplary plan view of a latching mechanism. The receiver portion of the latching mechanism in this example includes a set of internal recesses 3106 and 3108. The internal recesses 3106 and 3108 lock and hold tabs of the connector portion into place, such as the tabs 2702 and 2704 in FIG. 27.

FIG. 34 is an exemplary perspective view of a receiver portion of a latching mechanism. The connector section of the latching mechanism in this example is released by pushing in to overcome spring pressure and turning counter-clockwise until male section tabs can exit through keyed slots 3102 and 3104.

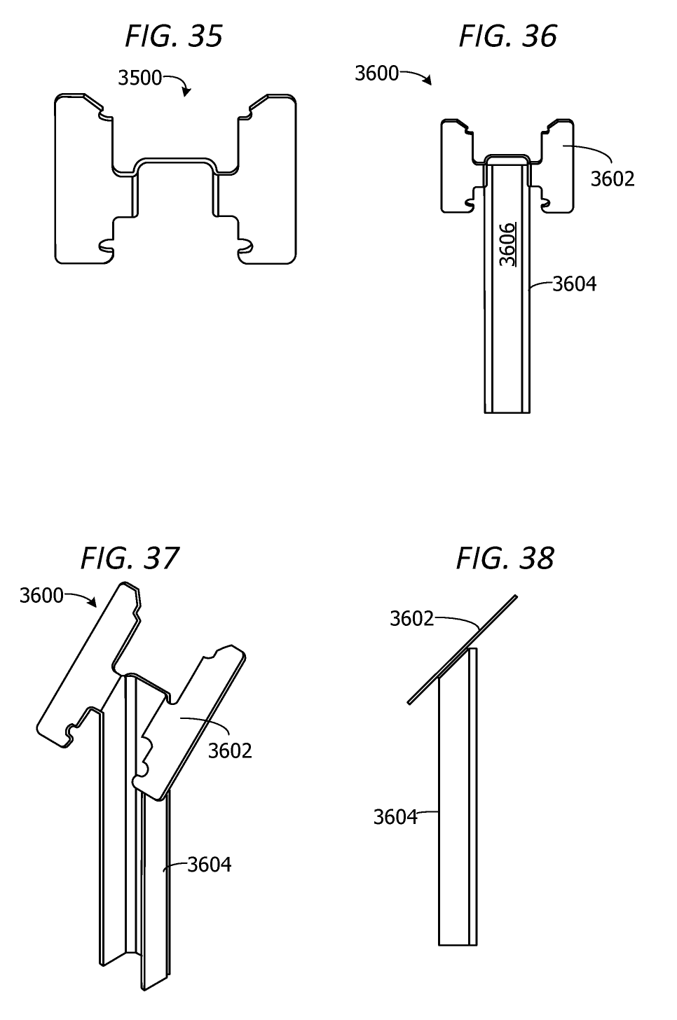

FIG. 35 is an exemplary front elevation view of an attachment member for a cable shroud, such as the shroud 932 in FIG. 9. The attachment member 3500 in this non-limiting example is a mounting panel or attachment means for attaching the cable shroud to an outer mounting ring assembly and/or swivel assembly. The attachment member 3500 may be secured to a back surface of the base plate using a set of screws, nails, brackets, bolts, or any other type of attachment device to secure the cable housing at a point of attachment for a detachable mounting device.

FIG. 36 is an exemplary back elevation view of a cable shroud. The cable shroud 3600 in this example includes an attachment member 3602 for mounting the cable shroud 3600 to a surface of a member of the outer mounting ring assembly. The cable shroud includes a protective cable guide 3604 enclosing an open space 3606 for receiving a set of retracting cables, such as the set of retracting cables 730 in FIG. 7.

FIG. 37 is an exemplary perspective view of a cable shroud. The cable shroud 3600 in this non-living example provides the cable guide 3604. A set of security cables and/or a set of communications cables are confined within the cable guide 3604. The attachment member 3602 for mounting/supporting the cable shroud 3600 to a surface of a member of the outer mounting ring assembly may be included.

FIG. 38 is an exemplary side view of a cable shroud. The cable guide 3604 in this non-limiting example feeds the set of retractable cables through a hole in the counter top to connect with components under the counter, such as the cable housing 1700 in FIG. 17. The attachment member 3602 for mounting the cable shroud 3600 may be provided to support a surface of a member of the card reader device and/or the outer mounting ring assembly

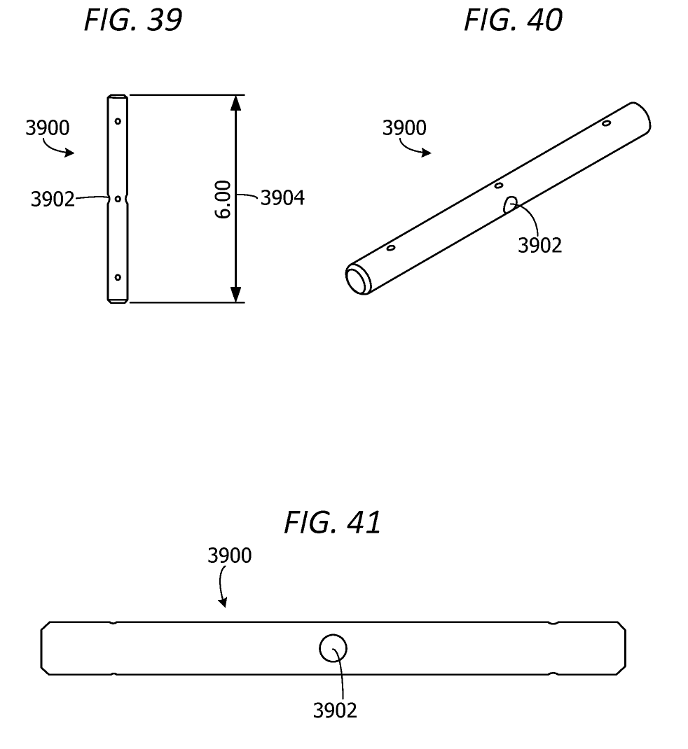

FIG. 39 is an exemplary plan view of a weight rod. The weight rod 3900 is a rod used to mount one or more collars for weight, such as the weight rod 928 in FIG. 9. The weight rod 3900 in this example includes an aperture 3902 configured to accept insertion of a pin through the aperture.

The weight rod 3900 may also include a length 3904 of the weight rod. The length 3904 in this example is six centimeters. However, the examples are not limited to a six centimeters length. The weight rod in other examples may be longer or shorter than six centimeters in length.

FIG. 40 is an exemplary perspective view of a weight rod. The weight rod 3900 in this example includes the aperture 3902 located substantially half-way down the length of the weight rod. In other words, the aperture 3902 is located approximately in the middle of the weight rod.

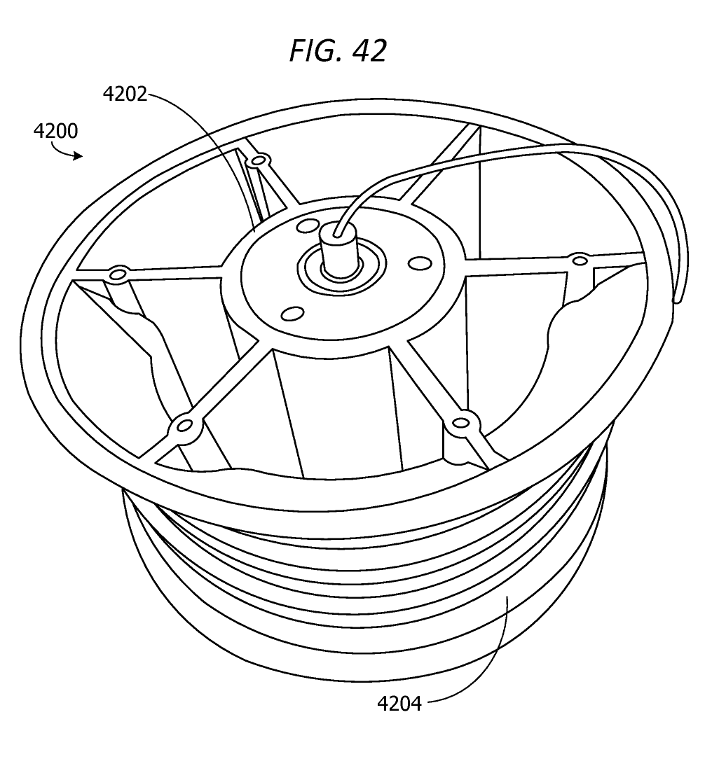

FIG. 41 is a cross-section view of a weight rod. The aperture 3902 in this non-limiting example is a hole for a pin which is used to attach one or more security cables to the weight rod 3900. The one or more security cables include security cables such as the set of security cables 722 in FIG. 7.

FIG. 42 is an exemplary perspective view of a reel associated with a retractor device. The reel 4200 is a pulley-like device for retracting or winding up a set of cables, such as cable 4204. The reel 4200 in this example incorporates a slip ring 4202 in the center of the reel 4200. The slip ring 4202 allows the cable 4204 to be wound on the spool without becoming twisted or tangled. The slip ring 4202 maintains electrical contact for up to five conductors during rotation of the reel 4200.

In one example, a retractor device utilizes the reel 4200 to loosely wind data cable up on the reel 4200. The slip ring 4202 in some example may include a set of leads out of the center. Internal to the slip ring 4202 in this example is a set of contact points that can slide over each other so the reel 4200 is able to spin without losing contact from one end of the lead to another. The reel 4200 does not cause the cable to twist up as the cable is wound up on the reel. The reel 4200 may be located below a surface of a POS device or other fixture supporting the card reader device.

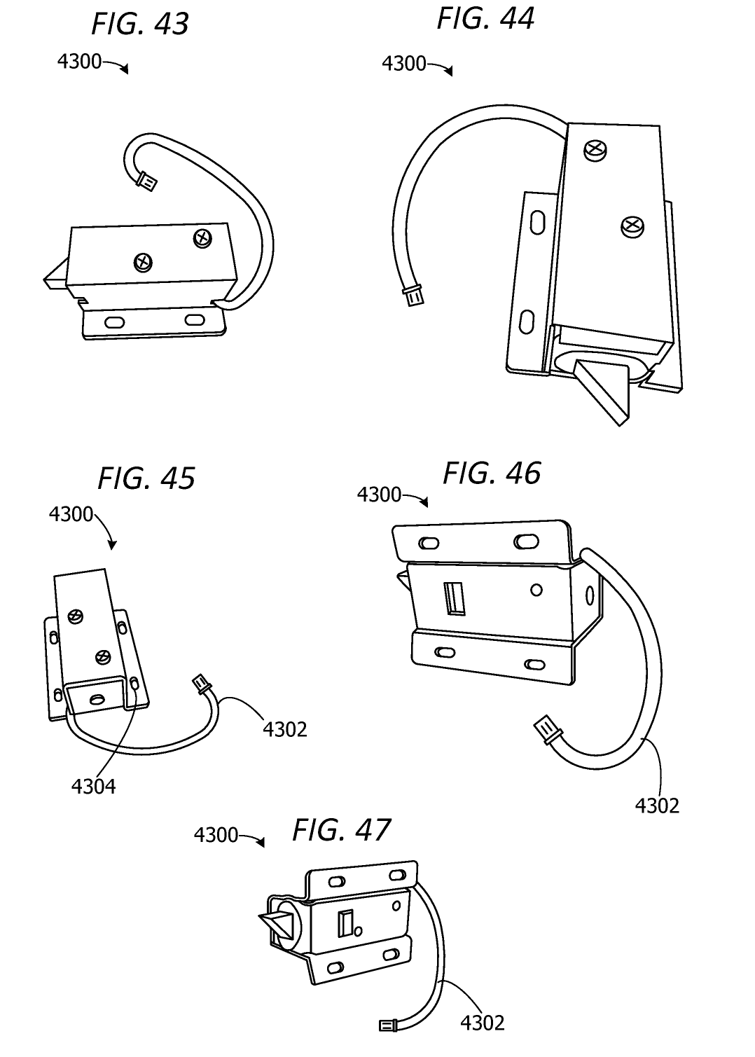

FIG. 43 is an exemplary perspective view of a top of a solenoid release device. The solenoid release device 4300 in this example is a mechanism for latching the detachable mounting device, such as, but not limited to, the solenoid release device 715 in FIG. 7.

FIG. 44 is another exemplary perspective view of a top of a solenoid release device. The solenoid release device 4300 provides a means for electrically triggering release of the detachable mounting device from a portion of the POS fixture in this non-limiting example.

FIG. 45 is yet another exemplary perspective view of a top of a solenoid release device. The solenoid release device 4300 may include one or more apertures 4304 for attaching the solenoid release device 4300 to another surface or member of the detachable mounting device. The solenoid release device 4300 in some examples includes one or more electrical supply wires 4302 providing electricity to enable electrical latching, such as, but not limited to, the electric latching mechanism 716 in FIG. 6.

In one example, the solenoid release device is mounted or attached to another member of the detachable mounting device using a set of screws inserted at the one or more apertures. The one or more apertures may include an aperture or screw hole, such as the aperture 4304.

FIGS. 46 and 47 provide exemplary perspective views of a bottom of a solenoid release device. The solenoid release device 4300 in some examples includes one or more electrical supply wires 4302 providing electricity to enable electrical latching, such as, but not limited to, the electric latching mechanism 716 in FIG. 6.

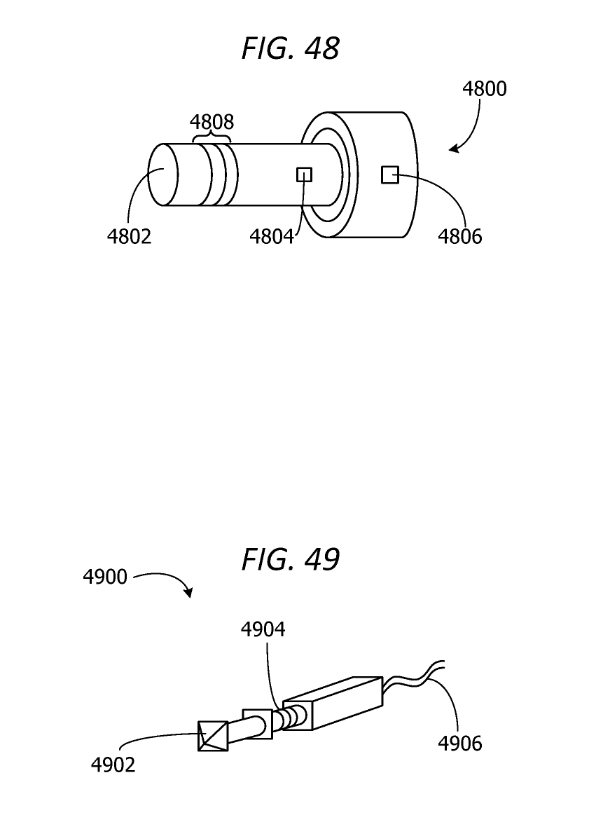

FIG. 48 is an exemplary perspective view of a threaded receiver device. The threaded receiver 4800 in this example includes an attachment 4802 configured to attach the threaded receiver to the outer mounting ring assembly. A plunger hole 4804 and 4806 are apertures for latching a plunger of a connector portion of a latching mechanism, such as, but not limited to, a solenoid device shown in FIG. 49 below. The plunger holes 4804 and 4806 are located in a receiver portion of the latching mechanism in this example. However, in other examples, the plunger holes 4804 and/or 4806 may be located on the outer mounting ring assembly.

A set of threads 4808 are included on the attachment 4802 in some examples. The set of threads 4808 for self-alignment or self-straightening of the latching mechanism.

FIG. 49 is an exemplary perspective view of a connector device of a latching mechanism. The connector device 4900 in this example includes a ramped plunger mechanism 4902. The plunger mechanism is ramped to allow placing the outer mounting ring assembly back onto the receiver device without activating the solenoid receiver device.

The piston 4904 in this example is extended with the power turned off (locking configuration). The piston 4904 retracts with activation (power turned on). This enables the electric latching mechanism. The electricity/power may be supplied to the piston 4904 via an electrical cable 4906 or other electrical wiring to the latching mechanism.

FIG. 50 is an exemplary flow chart illustrating operation of the computing device to generate a release signal to self-release the outer mounting ring assembly. The process shown in FIG. 50 may be performed by a controller associated with a detachable mounting device, such as, but not limited to, the controller 209 in FIG. 2, the detachable mounting device 104 in FIG. 1, the detachable mounting device 204 in FIG. 2, and/or the detachable mounting device 316 in FIG. 3.

The process begins by receiving sensor data from a set of sensors at operation 5002. The sensor data is data generated by a set of sensors 202 in FIG. 2 and/or the set of sensors 306 in FIG. 6. The sensor data may include data obtained from a camera, an RFID tag, a beacon, a microphone, and/or any other type of sensor data, such as the sensor data 304 in FIG. 3.

The sensor data is analyzed at operation 5004. The sensor data may be analyzed by a controller running on a detachable mounting device such as the controller 209 in FIG. 2 and/or a self-release analyzer component executing on a processor, such as the self-release analyzer 330 in FIG. 3. The sensor data may be analyzed by a processor and/or memory on the detachable mounting device, on the user device 312 in FIG. 3, or on the computing device 303 in FIG. 3. A determination is made as to whether a mobility aid device is detected at operation 5006. A mobility aid device may be a wheelchair, a walker, motorized cart, or any other mobility aid, such as the mobility aid device in 224 in FIG. 2. If yes, the detachable mounting device automatically detaches at operation 5012. The process terminates thereafter.

Returning to operation 5006, if a mobility aid device is not recognized based on the analyzed sensor data, a determination is made as to whether a user device associated with the user is recognized at operation 5008. The determination is made by the self-release analyzer component based on the analyzed sensor data. If the user device is recognized, the detachable mounting device automatically detaches at operation 5012. The process terminates thereafter.

Returning to operation 5008, if a motorized cart is not recognized based on the analyzed sensor data, a determination is made as to whether a release signal is received at operation 5010. A release signal may be received from a manual release device, such as the manual release control 234 in FIG. 2 or a user device 312 in FIG. 3.

If a release signal is received by the detachable mounting device at operation 5010, the detachable mounting device automatically detaches at operation 5012. The process terminates thereafter.

While the operations illustrated in FIG. 50 are performed by a detachable mounting device, aspects of the disclosure contemplate performance of the operations by other entities. For example, a computing device or a cloud service may perform one or more of the operations, such as the user device 312 in FIG. 3 and/or the computing device 302 in FIG. 3.

### Additional Examples

In some examples, the detachable card reader mounting device provides a means for individuals with disabilities to manage their own debit and credit card transactions via the detachable card reader mounting device. In one example, a user may remove a mounted card reader device with a simple twist to release motion and place it in their lap to scan their debit card, credit card, or gift card. When the transaction is complete, the mounted card reader device may be manually returned to the card reader stand on the POS fixture or automatically returned via a retractor device. In another example, the detachable mounting device includes mechanical devices to aid in retracting the mounted card reader device by relieving some of the weight of the device.

In an example, if a user with a disability approaches a POS fixture, the user may detach the mounted card reader device from the POS fixture without having to stand or get out of a wheelchair or other similar type of mobility aid device. The user may detach and return the mounted card reader device with minimal instructions.

In some examples, the user may remove/detach the mounted card reader device from the POS fixture by a push in and rotate counter clockwise motion to remove the mounted card reader device. The user may complete a transaction while holding the detached card reader device or placing the device in their lap. The user may replace the mounted card reader (payment device) by placing the mounted card reader device in position and rotating it clock wise to secure it back on the POS fixture.

In other examples, the set of security cables prevents the mounted card device from being lost, stolen, or permanently removed from the POS fixture. This may be accomplished in one example by securing the mounted card reader device with a security type cable that retracts into a cable housing partially embedded or integrated into the POS fixture along with the standard communication cable that the card reader device requires.

A padded ring holder is provided in another example to cushion and eliminate/minimize sharp edges or rough surfaces which may cause user discomfort. The padded rubber outer ring surround/encircles the mounted card reader device providing a comfortable set of handles for the user to hold/grip.

A cable retractor in another example retracts the mounted card reader device autonomously if the mounted card reader device is dropped or simply released by the user.

Other examples provide a solenoid release system which locks the mounted card reader device in place on the POS fixture for normal usage and unlocks the outer mounting ring assembly when detachment of the mounted card reader is indicated, such as for a user with a selected preference for detaching the mounted card reader, a disabled user, a user on a motorized cart, a user taller or shorter than a recommended convenient height range for the current location of the mounted card reader device, etc.

Once the solenoid releases the outer mounting ring assembly, in some examples, there is very little or no tension in the set of cables. The user applies a simple counter clock wise turn to remove the ring holder (which the card reader device is mounted to) by use of a threaded receiver.

In another example, when a detached card reader device is replaced on the fixed portion of the detachable mounting device on the POS fixture, the solenoid release device locks the mounted card reader back in place. If the mounted card reader in unintentionally unlocked/detached, a simple slight turn in an opposite direction (counter-clockwise) locks the mounted card reader device back in place.

In one example, the set of contacts includes a two metal contacts. In this example, one metal contact is located on opposite sides the ring holder. If a user wants to detach the mounted card reader device, the user places their hand in a position that would cover each of the metal contact points for a threshold contact period-of-time. The threshold time is a user-selected variable value. The solenoid release device in this example releases the lock and allows the mounted card reader device to be removed from the POS fixture. This solution provides a backup means for detaching the mounted card reader device if the RFID tag reader/video analysis methods are unavailable. In other examples, the set of contact points are utilized in addition to/in conjunction with the analysis of sensor data to determine when/if to release the mounted card reader device from the POS fixture.

In the case of the video analysis solution, the system analyzes image capture data generated by a set of cameras to recognize a user in a seated position and/or a user utilizing a mobility aid device, such as a wheelchair, walker, crutches, etc. The system activates the solenoid release device which unlocks the ring holder so that the mounted card reader device may be removed from the POS fixture.

In another example, the system analyzes RFID tag data to determine whether to release the mounted card reader data for a selected user. If the RFID tag data indicates a user using a mobility aid device, such as a wheelchair or motorized cart, the system automatically detaches the mounted card reader device as the user approaches the POS fixture to complete a transaction.

In other example, a manual release button may be utilized to release the mounted card reader device. The manual release button in some examples may be a button located on the POS fixture for an employee, associate, personnel, manager, or other user. The manual release button may be located on the mounted card reader device for the user/customer to select in other examples.

In another example, the manual release button may be an icon or other selection means provided by a POS application executing on a user device. The user may select the manual release button on the mobile user device to trigger release/detachment of the mounted card reader device.

The padded ring holder in other examples protects the mounted card reader device from being damaged if a user drops the mounted card reader device, it ensures easy grip for the user, and covers screws or other attachment means beneath the padding.

In some examples, the system may include an override button on a cashier's side that communicates with the solenoid release device/latching mechanism to lock the mounted card reader back in place if the mounted card reader is automatically released but the customer does not want to pull the mounted card reader out of the POS fixture.

In other examples, the retractor device includes a weighted cable system having at least one weight and/or weight rod attached to at least one cable within the cable housing to retract one or more cables and prevent the cable from swinging around and tangling when extended or when being retracted back into the cable housing.

Alternatively, or in addition to the other examples described herein, examples include any combination of the following:
a set of security cables configured to anchor the outer mounting ring assembly to at least a portion of the cable housing embedded within the POS fixture at the point of attachment while the outer mounting ring assembly is detached from the POS fixture;
wherein the solenoid release device includes an electric latching mechanism;
a set of sensors associated with the POS fixture configured to generate sensor data associated with one or more users within a user-defined proximity of the POS fixture;
a self-release analyzer component analyzing the sensor data using orientation recognition data to determine whether the user is in a sitting position or a standing position, wherein the self-release analyzer component triggers self-release of the outer mounting ring assembly from the POS fixture on condition the user is in the sitting position;
a self-release analyzer component analyzing the sensor data using height recognition data to determine a substantial height of the user, wherein the self-release analyzer component triggers self-release of the outer mounting ring assembly from the POS fixture on condition the height of the user is greater than a maximum height threshold or less than a minimum height threshold;
wherein the sensor data includes radio frequency identification (RFID) tag data;
a self-release analyzer component analyzing the RFID tag data to determine whether to self-release the outer mounting ring assembly for utilization by the user, wherein the self-release analyzer component triggers self-release of the outer mounting ring assembly from the POS fixture on condition the RFID tag data indicates self-release;
a set of contact points associated with the ring holder, wherein the solenoid release device automatically detaches the outer mounting ring assembly in response to detecting a user contact with at least one contact point in the set of contact points for a contact threshold time;
a signal receiver configured to receive a signal from a POS application running on a user device associated with the user, wherein the signal indicates self-release of the outer mounting ring assembly, wherein the signal receiver triggers self-release of the outer mounting ring assembly in response to receiving the signal from the user device;
wherein the retractable set of cables comprises a set of communications cables transmitting user input from the card reader, wherein the retractor device automatically retracts the outer mounting ring assembly with the attached card reader back to a position associated with the point of attachment on the POS fixture in response to an absence of user input received from the card reader for an inactivity threshold time;
an outer mounting ring assembly comprising a ring holder, a base plate attached to the card reader device to the outer mounting ring assembly, and a set of contact points associated with the ring holder, the outer mounting ring assembly removably attached to a latching mechanism coupled to a portion of a member of a POS fixture at a point of attachment, the latching mechanism configured to release the outer mounting ring assembly enabling the outer mounting ring assembly to detach from the POS fixture in response to detecting user contact with the set of contact points for a contact threshold time;
a retractable set of cables comprising a security cable and a communications cable, the retractable set of cables comprising a first end of the security cable coupled to the card reader device and a second end of the security cable coupled to a cable housing, at least a portion of the cable housing coupled to the member of the POS fixture, the security cable extends out of the cable housing as a user holding the detached outer mounting ring assembly moves the outer mounting ring assembly with the attached card reader away from the point of attachment;
a retractor device configured to self-retract the security cable into the cable housing in response to the user relinquishing the detached outer mounting ring assembly, the retractor device returning the detached outer mounting ring assembly to the point of attachment associated with the POS fixture;
wherein the ring holder is a padded ring holder comprising a set of handles;
wherein the ring holder is a urethane encapsulated ring;
a connector device associated with the outer mounting ring assembly configured to removably attach to a receiver device associated with the POS fixture;
a manual release control configured to initiate self-release of the outer mounting ring assembly in response to a user selection of the manual release control;
an RFID tag reader configured to obtain RFID tag data from an RFID tag associated with a user cart or an RFID tag associated with a user mobility aid device;
a self-release analyzer component analyzing the RFID tag data to determine whether to self-release the outer mounting ring assembly for utilization by the user, wherein the self-release analyzer component triggers self-release of the outer mounting ring assembly on condition the RFID tag data indicates self-release;
a self-release analyzer component analyzing sensor data generated by a set of sensors associated with the POS fixture to determine whether to self-release the outer mounting ring assembly, wherein the self-release analyzer component triggers the self-release is the analyzed sensor data indicates the user is associated with a mobility aid device, an orientation of the user is a sitting position, a height of the user is greater than a maximum height threshold, or the height of the user is less than a minimum height threshold;
a set of tabs associated with the latching mechanism, wherein the set of tabs locks the outer mounting ring device to the POS fixture in a locked configuration;
wherein pushing down on the outer mounting ring device and turning the outer mounting ring device counter-clockwise until the set of tabs exit through a set of keyed slots detaches the outer mounting ring device from the POS fixture;
an outer mounting ring assembly comprising a ring holder attached to a base plate, the base plate comprising a card reader mounted to at least a portion of the base plate;
a retractable set of cables, a first end of the set of cables connected to the card reader and a second end of the set of cables connected to an interior cavity of a cable housing embedded within a portion of a counter of a point-of-sale (POS) fixture, the set of cables threaded through an aperture within the base plate;
a retractor device configured to automatically retract the set of cables within the cable housing in response to returning the outer mounting ring assembly to a point of attachment associated with the POS fixture;
a solenoid release device configured to removably attach the outer mounting ring assembly to the portion of the counter of the POS fixture at the point of attachment in a locked configuration of the outer mounting ring assembly and configured to unlock the outer mounting ring assembly from the portion of the counter of the POS fixture in response to receiving a release signal;
the retractor device releases at least one cable in the set of cables to enable at least a portion of the at least one cable to extend outside the cable housing during detachment of the outer mounting ring assembly from the POS fixture;
the latching mechanism comprising a connector component associated with the outer mounting ring assembly and a receiver component associated with the portion of the POS fixture;
the latching mechanism configured to release the outer mounting ring assembly enabling the outer mounting ring assembly to detach from the POS fixture in response to rotation of the latching mechanism in a first direction until the latching mechanism releases the outer mounting ring assembly;
the security cable extending as the detached outer mounting ring assembly moves away from the point of attachment;
a retractor device configured to autonomously retract the at least one security cable into the cable housing on condition of relinquishment of the detached outer mounting ring assembly by a user utilizing the mounted card reader;
the latching mechanism configured to lock the outer mounting ring assembly to the portion of the POS fixture in response to rotation of the latching mechanism in a second direction until the latching mechanism engages.

At least a portion of the functionality of the various elements in the figures may be performed by other elements in the figures, or an entity (e.g., processor, web service, server, application program, computing device, etc.) not shown in the figures.

In some examples, the operations illustrated in FIG. 50 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform tasks or implement abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A detachable card reader mounting system comprising:
an outer mounting ring assembly comprising a ring holder attached to a base plate, the base plate comprising a card reader mounted to at least a portion of the base plate;
a retractable set of cables, a first end of the set of cables connected to the card reader and a second end of the set of cables connected to an interior cavity of a cable housing embedded within a portion of a counter of a point-of-sale (POS) fixture, the set of cables threaded through an aperture within the base plate;
a retractor device configured to automatically retract the set of cables within the cable housing in response to returning the outer mounting ring assembly to a point of attachment associated with the POS fixture;
a solenoid release device configured to removably attach the outer mounting ring assembly to the portion of the counter of the POS fixture at the point of attachment in a locked configuration of the outer mounting ring assembly and configured to unlock the outer mounting ring assembly from the portion of the counter of the POS fixture in response to receiving a release signal, the retractor device releases at least one cable in the set of cables to enable at least a portion of the at least one cable to extend outside the cable housing during detachment of the outer mounting ring assembly from the POS fixture.

2. The detachable card reader mounting system of claim 1 wherein the retractable set of cables further comprises:
a set of security cables configured to anchor the outer mounting ring assembly to at least a portion of the cable housing embedded within the POS fixture at the point of attachment while the outer mounting ring assembly is detached from the POS fixture.

3. The detachable card reader mounting system of claim 1, wherein the solenoid release device further comprises:
an electric latching mechanism.

4. The detachable card reader mounting system of claim 1, further comprising:
a set of sensors associated with the POS fixture configured to generate sensor data associated with one or more users within a user-defined proximity of the POS fixture.

5. The detachable card reader mounting system of claim 4, further comprising:
a self-release analyzer component analyzing the sensor data using orientation recognition data to determine whether the user is in a sitting position or a standing position, wherein the self-release analyzer component triggers self-release of the outer mounting ring assembly from the POS fixture on condition the user is in the sitting position.

6. The detachable card reader mounting system of claim 4, further comprising:
a self-release analyzer component analyzing the sensor data using height recognition data to determine a substantial height of the user, wherein the self-release analyzer component triggers self-release of the outer mounting ring assembly from the POS fixture on condition the height of the user is greater than a maximum height threshold or less than a minimum height threshold.

7. The detachable card reader mounting system of claim 4, wherein the sensor data includes radio frequency identification (RFID) tag data and further comprising:
a self-release analyzer component analyzing the RFID tag data to determine whether to self-release the outer mounting ring assembly for utilization by the user, wherein the self-release analyzer component triggers self-release of the outer mounting ring assembly from the POS fixture on condition the RFID tag data indicates self-release.

8. The detachable card reader mounting system of claim 1, further comprising:
a set of contact points associated with the ring holder, wherein the solenoid release device automatically detaches the outer mounting ring assembly in response to detecting a user contact with at least one contact point in the set of contact points for a contact threshold time.

9. The detachable card reader mounting system of claim 1, further comprising:
a signal receiver configured to receive a signal from a POS application running on a user device associated with the user, wherein the signal indicates self-release of the outer mounting ring assembly, wherein the signal receiver triggers self-release of the outer mounting ring assembly in response to receiving the signal from the user device.

10. The detachable card reader mounting system of claim 1, wherein the retractable set of cables comprises a set of communications cables transmitting user input from the card reader, wherein the retractor device automatically retracts the outer mounting ring assembly with the attached card reader back to a position associated with the point of attachment on the POS fixture in response to an absence of user input received from the card reader for an inactivity threshold time.

11. A detachable mounting device for a card reader comprising:
an outer mounting ring assembly comprising a ring holder, a base plate, and a card reader device mounted to the outer mounting ring assembly;
a set of contact points associated with the ring holder, the outer mounting ring assembly removably attached to a latching mechanism coupled to a portion of a member of a POS fixture at a point of attachment, the latching mechanism configured to release the outer mounting ring assembly enabling the mounted card reader device to detach from the POS fixture in response to detecting user contact with the set of contact points for a contact threshold time;
a retractable set of cables comprising a security cable and a communications cable, the retractable set of cables comprising a first end of the security cable coupled to the mounted card reader device and a second end of the security cable coupled to a cable housing, at least a portion of the cable housing coupled to the member of the POS fixture, the security cable extending out of the cable housing as a user holding the mounted card reader device moves the outer mounting ring assembly with the mounted card reader device away from the point of attachment associated with the POS fixture; and
a retractor device configured to self-retract the security cable into the cable housing in response to the user relinquishing the mounted card reader device coupled to the outer mounting ring assembly, the retractor device returning the mounted card reader device to the point of attachment associated with the POS fixture.

12. The detachable mounting device of claim 11, wherein the ring holder is a padded ring holder comprising a set of handles.

13. The detachable mounting device of claim 11, wherein the ring holder is a urethane encapsulated ring.

14. The detachable mounting device of claim 11, further comprising:
a connector device associated with the outer mounting ring assembly configured to removably attach to a receiver device associated with the POS fixture.

15. The detachable mounting device of claim 11, further comprising:
a manual release control configured to initiate self-release of the outer mounting ring assembly in response to a user selection of the manual release control.

16. The detachable mounting device of claim 11, further comprising:
an RFID tag reader configured to obtain RFID tag data from an RFID tag associated with a user cart or an RFID tag associated with a user mobility aid device.

17. The detachable mounting device of claim 16, further comprising:
a self-release analyzer component analyzing the RFID tag data to determine whether to self-release the mounted card reader device coupled to the outer mounting ring assembly for utilization by the user, wherein the self-release analyzer component triggers self-release of the mounted card reader device on condition the RFID tag data indicates self-release.

18. The detachable mounting device of claim 11, further comprising:
a self-release analyzer component analyzing sensor data generated by a set of sensors associated with the POS fixture to determine whether to self-release the outer mounting ring assembly, wherein the self-release analyzer component triggers the self-release of mounted card reader device on condition the analyzed sensor data indicates the user is associated with a mobility aid device, an orientation of the user includes a sitting position, a height of the user is greater than a maximum height threshold, or the height of the user is less than a minimum height threshold.

19. The detachable mounting device of claim 11, further comprising:
a set of tabs associated with the latching mechanism, wherein the set of tabs locks the outer mounting ring device to the POS fixture in a locked configuration, and wherein pushing down on the outer mounting ring device and turning the outer mounting ring device counter-clockwise until the set of tabs exit through a set of keyed slots detaches the mounted card reader device from the POS fixture.

20. A detachable card reader mounting system comprising:
an outer mounting ring assembly comprising a ring holder, a base plate configured to mount a card reader device to the outer mounting ring assembly, and a latching mechanism configured to removably attach the outer mounting ring assembly to a portion of a POS fixture at a point of attachment, the latching mechanism comprising a connector component associated with the outer mounting ring assembly and a receiver component associated with the portion of the POS fixture, the latching mechanism configured to release the outer mounting ring assembly enabling the outer mounting ring assembly to detach from the POS fixture in response to rotation of the latching mechanism in a first direction until the latching mechanism releases the outer mounting ring assembly;
a cable housing configured to enclose a retractable set of security cables, the retractable set of security cables comprising a first end of at least one security cable coupled to the card reader and a second end of the at least one security cable coupled to a portion of the cable housing, the security cable extending as the detached outer mounting ring assembly moves away from the point of attachment; and
a retractor device configured to autonomously retract the at least one security cable into the cable housing on condition of relinquishment of the detached outer mounting ring assembly, the retractor device returning the detached outer mounting ring assembly to the point of attachment associated with the POS fixture, the latching mechanism configured to lock the outer mounting ring assembly to the portion of the POS fixture in response to rotation of the latching mechanism in a second direction until the latching mechanism engages.
